(19) United States
(12) Patent Application Publication
(10) Pub. No.: US 2011/0219323 A1
(43) Pub. Date: Sep. 8, 2011

(54) MOBILE DEVICE AND METHOD FOR LETTER INPUT BASED ON CUT OR COPY AND PASTE

(75) Inventors: Hyun Chul Woo, Dalseo-gu (KR); Dong Han Kang, Suseong-gu (KR)

(73) Assignee: SAMSUNG ELECTRONICS CO., LTD., Suwon-si (KR)

(21) Appl. No.: 13/040,023

(22) Filed: Mar. 3, 2011

(30) Foreign Application Priority Data
Mar. 3, 2010 (KR) 10-2010-0019039
Aug. 10, 2010 (KR) 10-2010-0076939

(51) Int. Cl. G06F 3/02; G06F 3/048

(52) U.S. Cl. 715/769; 345/168; 715/781

(57) ABSTRACT

A mobile device allows a letter input based on a cut or copy and paste technique. In a method for inputting a letter, the mobile device displays letters inputted by a user in a letter input window. The mobile device receives the selection of at least one of the displayed letters and the selection of a position in the letter input window. Then the mobile device moves and displays the selected at least one letter to the selected position. This letter input method is available for any types of the mobile devices regardless of being based on a touch screen or not.

### CROSS-REFERENCE TO RELATED APPLICATION(S) AND CLAIM OF PRIORITY

The present application is related to and claims priority to an application filed in the Korean Intellectual Property Office on Mar. 3, 2010 and assigned Serial No. 10-2010-0019039 and an application filed in the Korean Intellectual Property Office on Aug. 10, 2010 and assigned Serial No. 10-2010-0076939, the contents of which are incorporated herein by reference.

### TECHNICAL FIELD OF THE INVENTION

The present invention relates in general to a mobile device and, more particularly, to a letter input technology used for mobile devices and based on a cut or copy and paste technique.

### BACKGROUND OF THE INVENTION

With remarkable growths of related technologies, a great variety of mobile devices are increasingly popularized in these days. A mobile device not only inherently provides a voice call service using a mobile communication network, but also optionally offers a video call service, a data transmission service, and any other various additional services, thus evolving into a multimedia communication device.

Normally, a user of the mobile device performs an input of letters by selecting keys displayed on a touch screen or arranged in a keypad. When a user wants to transfer or repeatedly input some of letters that have been already inputted, he or she has to delete inputted letters and then input the desired letters. Unfortunately, this often may be inconvenient to a user.

### SUMMARY OF THE INVENTION

To address the above-discussed deficiencies of the prior art, it is a primary object to provide a mobile device and method for a letter input based on a cut or copy and paste technique.

According to one aspect of the present invention, provided is a method for inputting a letter in a mobile device. The method includes: displaying letters inputted by a user in a letter input window; selecting at least one of the displayed letters; selecting a position in the letter input window; and moving and displaying the selected at least one letter to the selected position.

According to another aspect of the present invention, provided is a mobile device that includes: a display unit configured to display a letter input window, at least one letter and a cursor; an input unit configured to have at least one key and to receive user's input instructions; and a control unit configured to enable the display unit to display letters inputted by a user in the letter input window, to select at least one of the displayed letters through the input unit, to select a position in the letter input window through the input unit, and to enable the display unit to move and display the selected at least one letter to the selected position.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of the configuration of a mobile device in accordance with an exemplary embodiment of the present invention;

FIGS. 2A and 2B illustrate a method for inputting letters in the mobile device in accordance with the first exemplary embodiment of the present invention;

FIG. 3 illustrates screen views for the letter input method in accordance with an embodiment of the present invention;

FIGS. 4A and 4B illustrate a method for inputting letters in the mobile device in accordance with an embodiment of the present invention;

FIG. 5 illustrates screen views for the letter input method in accordance with an embodiment of the present invention;

FIGS. 6A and 6B illustrate a method for inputting letters in the mobile device in accordance with an embodiment of the present invention;

FIG. 7 illustrates screen views for the letter input method in accordance with an embodiment of the present invention;

FIG. 8 illustrates a schematic view of a mobile device not based on a touch screen;

FIGS. 9A and 9B illustrate a method for inputting letters in the mobile device in accordance with an embodiment of the present invention;

FIG. 10 illustrates screen views for the letter input method in accordance with an embodiment of the present invention;

FIGS. 11A and 11B illustrate a method for inputting letters in the mobile device in accordance with an embodiment of the present invention;

FIG. 12 illustrates screen views for the letter input method in accordance with the fifth exemplary embodiment of the present invention;

FIG. 13 illustrate a method for inputting letters in the mobile device in accordance with an embodiment of the present invention;

FIG. 14 illustrates screen views for the letter input method in accordance with an embodiment of the present invention;

FIGS. 15A and 15B illustrate a method for inputting letters in the mobile device in accordance with an embodiment of the present invention; and

FIG. 16 illustrates screen views for the letter input method in accordance with an embodiment of the present invention.

### DETAILED DESCRIPTION OF THE INVENTION

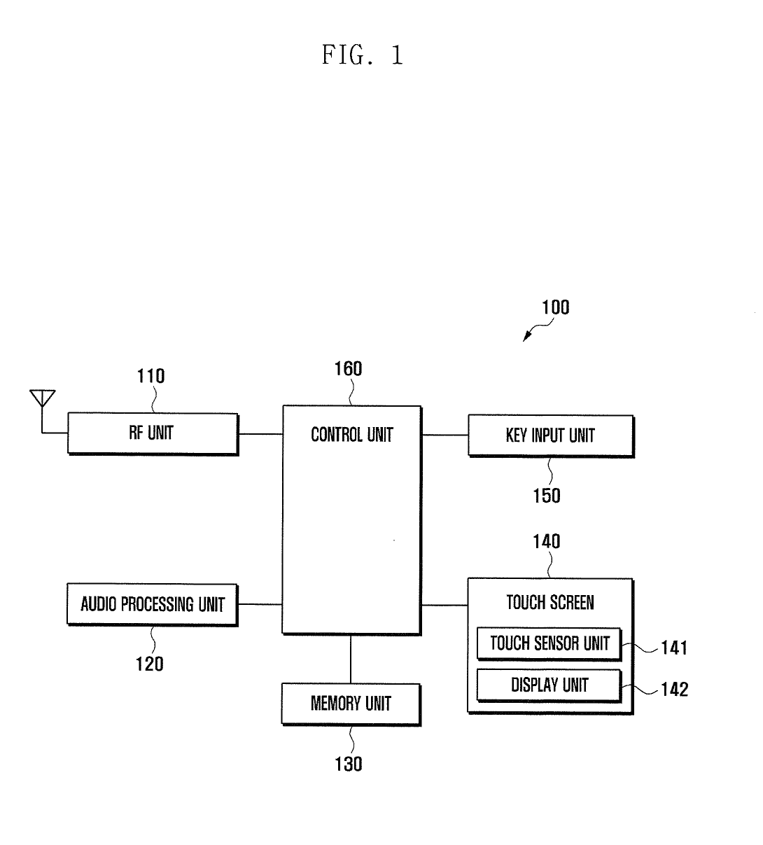

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications device. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

Although a mobile device will be described by example hereinafter, the present invention is not limited to the mobile device. Alternatively, this invention may be applied to any other electronic devices. Specifically, the mobile device according to embodiments of this invention may include a mobile communication terminal, a portable multimedia player (PMP), a personal digital assistant (PDA), a smart phone, an MP3 player, and the like. Additionally, the mobile communication terminal may include an IMT-2000 (International Mobile Telecommunication 2000) terminal, a WCDMA (Wideband Code Division Multiple Access) terminal, a GSM/GPRS (Global System for Mobile communication/General Packet Radio Service) terminal, a UMTS (Universal Mobile Telecommunication Service) terminal, and the like. The mobile device of this invention may be based on a touch screen or alternatively may have a normal keypad.

Among terms set forth herein, a ‘touch’ refers to an act of putting a user's finger or a stylus pen onto a touch screen. A ‘touch release’ refers to an act of removing a user's finger or a stylus pen from a touch screen. A ‘tap’ refers to a quick and continuous act of a touch and release on a touch screen. A ‘drag’refers to an act of moving a user's touch or stylus pen touch across a touch screen.

FIG. 1 illustrates a block diagram of the configuration of a mobile device 100 in accordance with an embodiment of the present invention. Referring to FIG. 1, the mobile device 100 includes a radio frequency (RF) unit 110, an audio processing unit 120, a memory unit 130, a touch screen 140, a key input unit 150, and a control unit 160.

The RF unit 110 performs a function to transmit and receive data for a wireless communication of the mobile device 100. Normally the RF unit 110 may include an RF transmitter that up-converts the frequency of an outgoing signal and then amplifies the signal, an RF receiver that amplifies an incoming signal with low-noise and down-converts the frequency of the signal, and the like. Additionally, the RF unit 110 may receive data through a wireless channel and then output it to the control unit 160, and also receive data from the control unit 160 and then transmit it through a wireless channel.

The audio processing unit 120 may include a codec, which may be composed of a data codec for processing packet data and an audio codec for processing an audio signal such as a voice. The audio processing unit 120 converts a digital audio signal into an analog audio signal through the audio codec and then outputs it through a speaker (SPK), and also convents an analog audio signal received from a microphone (MIC) into a digital audio signal through the audio codec.

The memory unit 130 stores programs and data required for operations of the mobile device 100 and may consist of a program region and a data region. The memory unit 130 may be formed of a volatile memory, a nonvolatile memory, or a combination thereof. The volatile memory includes a semiconductor memory such as DRAM and SRAM, and the nonvolatile memory includes a hard disk.

The touch screen 140 includes a touch sensor unit 141 and a display unit 142. The touch sensor unit 141 detects a user's touch input. The touch sensor unit 141 may be formed of touch detection sensors of a capacitive overlay type, a resistive overlay type or an infrared beam type, or formed of pressure detection sensors. Alternatively, any other various sensors capable of detecting a contact or pressure of an object may be used for the touch sensor unit 141. The touch sensor unit 141 detects a user's touch input, creates a detection signal, and transmits the signal to the control unit 160. The detection signal contains coordinate data of a user's touch input. If a drag act is inputted by a user, the touch sensor unit 141 creates a detection signal containing coordinate data of a moving path of a touched point and then transmits it to the control unit 160. In another embodiment, the mobile device 100 does not include the touch screen 140 and, instead, includes an input unit having a keypad, button keys, or the like.

The display unit 142 may be formed of LCD (Liquid Crystal Display), OLED (Organic Light Emitting Diode), AMOLED (Active Matrix OLED), or any equivalent. The display unit 142 visually offers a menu, input data, function setting information and any other various information of the mobile device 100 to a user. The display unit 142 performs a function to output a booting screen, an idle screen, a menu screen, a call screen, or any other application screens of the mobile device 100. In particular, the display unit 142 displays a letter input window, letters inputted by a user, and a cursor, and may optionally display a letter input key. If the mobile device 100 is not based on the touch screen, the display unit 142 may be separated from the touch sensor unit 141.

The key input unit 150 receives a user's key manipulation for controlling the mobile device 100, creates a related input signal, and then delivers it to the control unit 160. The key input unit 150 may be formed of a keypad having alphanumeric keys and navigation keys, and some function keys. If the touch screen 140 is enough to manipulate the mobile device, the key input unit 150 may be omitted. Also, if the mobile device is not based on the touch screen, the input unit 150 may act as a main input unit of the mobile device.

The control unit 160 performs a function to control the entire operation of the mobile device 100. Specifically, the control unit 160 enables the display unit 142 to display a letter input window, letters inputted by a user, and a line-like cursor. Additionally, the control unit 160 enables the touch sensor unit 141 to receive the selection of at least one of the letters displayed in the letter input window and also to receive the selection of a certain position in the letter input window. Then the control unit 160 enables the display unit 142 to move and display the selected at least one letter to the selected position.

In one embodiment, the control unit 160 enables the touch sensor unit 141 to receive a first touch inputted at one of the displayed letters or inputted between the displayed letters and also enables the display unit 142 to display the cursor in an input position of the first touch. Then, the control unit 160 enables the touch sensor unit 141 to receive a second touch inputted at the displayed cursor more than a given time and also enables the display unit 142 to change the line-like cursor into a block-like cursor. Thereafter, the control unit 160 enables the touch sensor unit 141 to receive a drag inputted along at least one of the displayed letters and also finds the at least one letter in an input path of the drag. In this case, the control unit 160 may enable the display unit 142 to change a graphic representation of the at least one letter found in the drag path.

In another embodiment, the control unit 160 enables the touch sensor unit 141 to receive a touch inputted at one of the displayed letters and also determines whether the touch is inputted more than a given time. If the touch is inputted more than the given time, the control unit 160 enables the display unit 142 to change the line-like cursor into a block-like cursor. Then the control unit 160 enables the touch sensor unit 141 to receive a drag inputted along at least one of the displayed letters and also finds the at least one letter in an input path of the drag. In this case as well, the control unit 160 may enable the display unit 142 to change a graphic representation of the at least one letter found in the drag path.

In still another embodiment, the control unit 160 enables the touch sensor unit 141 to receive a touch inputted at one of the displayed letters or inputted between the displayed letters and also to receive a drag inputted along at least one of the displayed letters. Then, the control unit 160 finds the at least one letter in an input path of the drag and also determines whether a direction of the drag is a first direction or a second direction. If the drag direction is the first direction, the control unit 160 may enable the display unit 142 to cut the selected at least one letter found in the drag path and then to paste the selected at least one letter onto the selected position. If the drag direction is the second direction, the control unit 160 may enable the display unit 142 to copy the selected at least one letter found in the drag path and then to paste the selected at least one letter onto the selected position.

In still another embodiment, when receiving the selection of a certain position in the letter input window through the touch sensor unit 141, the control unit 160 controls the display unit 142 to display a line-like cursor at the selected position. Also, when receiving a touch inputted at the displayed cursor through the touch sensor unit 141, the control unit 160 may enable the display unit 142 to move and display the selected at least one letter to the selected position.

In still another embodiment, the control unit 160 enables the touch sensor unit 141 to receive a touch inputted at the selected at least one letter and also to receive a drag inputted in the letter input window. Then, the control unit 160 finds an end position of the drag in order to select a certain position in the letter input window.

If the mobile device is not based on the touch screen, the control unit 160 enables the display unit 142 to move the cursor in response to a first input of a navigation key through the key input unit 150. Then, the control unit 160 enables the display unit 142 to change the line-like cursor into a block-like cursor in response to an input of a first key through the key input unit 150. Thereafter, the control unit 160 enables the display unit 142 to change a graphic representation of at least one letter selected by the passage of the block-like cursor in response to a second input of the navigation key through the key input unit 150. Additionally, the control unit 160 determines the selected at least one letter as a letter to be moved or copied in response to an input of a second key through the key input unit 150. Furthermore, in response to a second input of the second key through the key input unit 150, the control unit 160 may enable the display unit 142 to cut or copy the selected at least one letter and then to paste the selected at least one letter onto the selected position.

In still another embodiment, the control unit 160 enables the display unit 142 to move the cursor in response to a first input of a navigation key less than a first given time through the key input unit 150. Then the control unit 160 enables the display unit 142 to change the line-like cursor into a block-like cursor in response to a second input of the navigation key more than the first given time through the key input unit 150. Thereafter, the control unit 160 enables the display unit 142 to change a graphic representation of at least one letter selected by the passage of the block-like cursor in response to a third input of the navigation key less than a second given time through the key input unit 150. Additionally, the control unit 160 determines the selected at least one letter as a letter to be moved or copied in response to a fourth input of the navigation key more than the second given time through the key input unit 150. Furthermore, the control unit 160 enables the display unit 142 to move the cursor to the selected position in response to a fifth input of the navigation key more than a third given time through the key input unit 150. Additionally, in response to a sixth input of the navigation key more than a fourth given time through the key input unit 150, the control unit 160 may enable the display unit 142 to cut or copy the selected at least one letter and then to paste the selected at least one letter onto the selected position.

Meanwhile, the mobile device 100 according to any alternative embodiment of this invention may further include a separate sub display unit (not shown) in addition to the display unit 142 discussed above.

Described hereinafter is a method for inputting letters in the mobile device 100 discussed above.

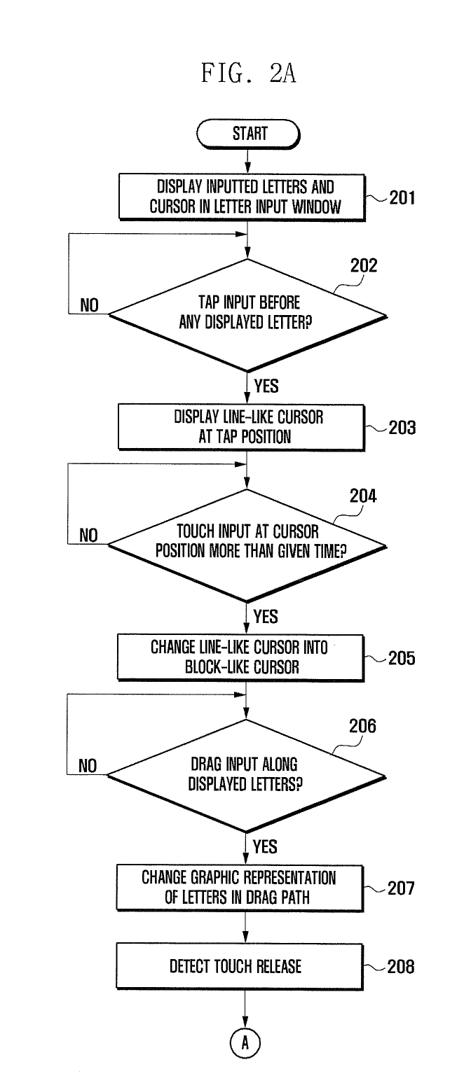

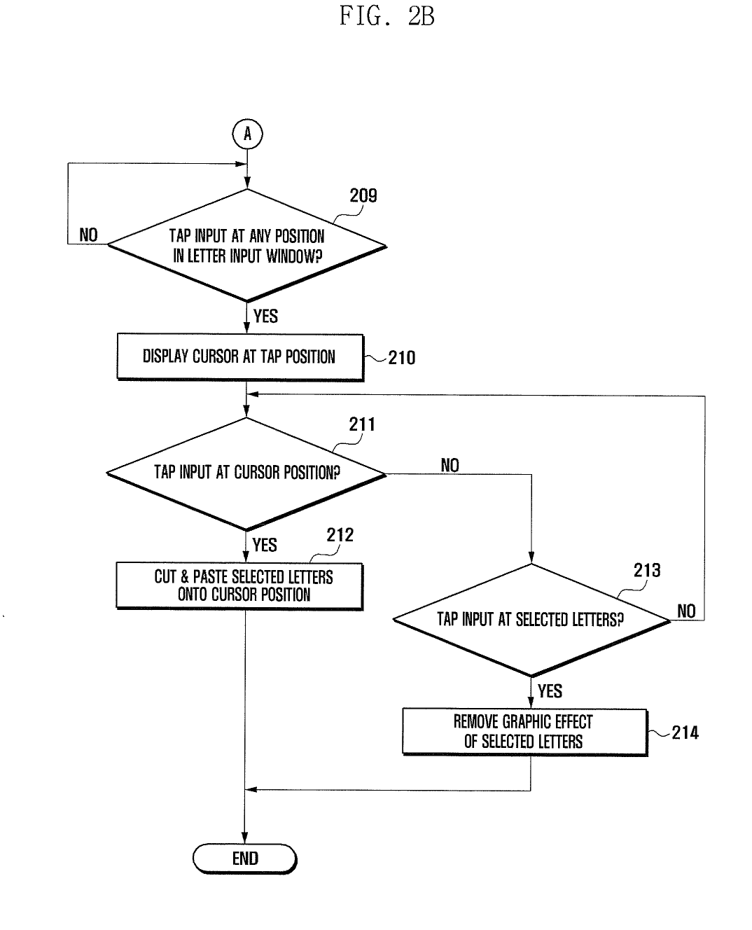

FIGS. 2A and 2B illustrate a method for inputting letters in the mobile device in accordance with an embodiment of the present invention. A first embodiment of this invention relates to a method for transferring the inputted letter(s) to other input position, based on a cut and paste technique.

Referring to FIGS. 1, 2A and 2B, the control unit 160 controls the display unit 142 to display letters inputted by a user and a cursor in a letter input window (block 201). Specifically, the control unit 160 controls the display unit 142 to display the letter input window, the line-like cursor and a number of letter keys. When a user touches one of the letter keys, the touch sensor unit 141 creates a touch signal and sends it to the control unit 160. Then, the control unit 160 receives the touch signal, finds the letter key touched by a user, and controls the display unit 142 to display a letter corresponding to the touched letter key and also to display the cursor at the next input position. In another embodiment, the control unit 160 controls the display unit 142 to display the letter input window and the cursor and not to display the letter keys. In this case, a user selects one of letter keys through the key input unit 150. Then, the key input unit 150 sends a key selection signal to the control unit 160, and the control unit 160 finds the letter key selected by a user. Additionally, the control unit 160 controls the display unit 142 to display a letter corresponding to the selected letter key and to display the cursor at the next input position.

Next, by controlling the touch sensor unit 141, the control unit 160 determines whether a user's tap is inputted before one of the displayed letters (block 202). Here, the touch sensor unit 141 creates a touch signal and sends it to the control unit 160. By receiving the touch signal, the control unit 160 can find a tap position and indentify the displayed letter after the tap position.

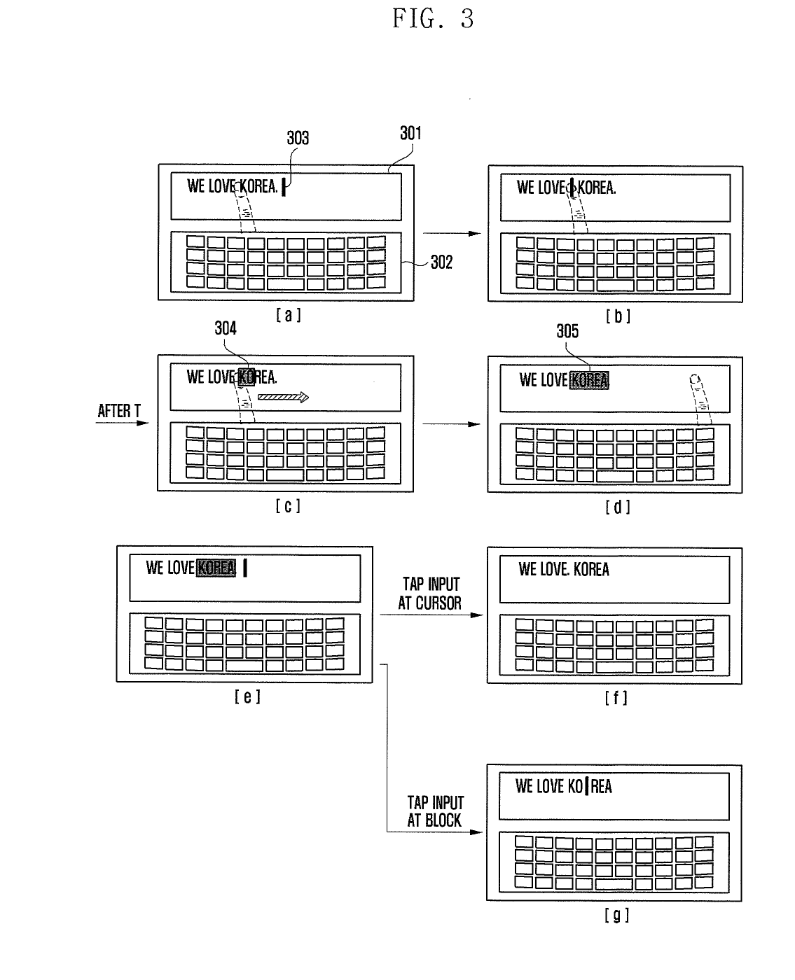

FIG. 3 illustrates screen views for the letter input method in accordance with the first exemplary embodiment of the present invention.

A stage [a] of FIG. 3 shows an example screen that is composed of the letter input window 301, the letter keys 302 and the line-like cursor 303. In addition, stage [a] further shows that the screen displays a set of letters inputted by a user (for example, a sentence ‘We love Korea.’). In stage [a], the cursor 303 is located at the last position of the sentence. Also, a user inputs a tap before a displayed letter ‘l’ in the letter input window 301.

Returning to FIGS. 2A and 2B, if it is determined in block 202 that the tap is inputted, the control unit 160 controls the display unit 142 to display the cursor at the tap position (block 203). Next, by controlling the touch sensor unit 141, the control unit 160 determines whether a user's touch is inputted at a cursor position more than a given time (block 204). Stage [b] of FIG. 3 shows an example screen in which the cursor is moved before a selected letter ‘l’ in response to a user's tap input. Also, stage [b] further shows that a user touches the moved cursor located before the selected letter ‘l’.

If a user's touch is inputted at the cursor position more than the given time, the control unit 160 controls the display unit 142 to change the line-like cursor into a block-like cursor (block 205). The block-like cursor may be square in shape and usually includes a darker color than a background color in the letter input window. Also, a letter overlapped with the block-like cursor may be displayed to have an opposite color. Stage [c] of FIG. 3 shows an example screen after a user touches the cursor position more than a given time (T) in stage [b]. In stage [c], the block-like cursor 304 is overlapped with the selected letter ‘l’ and includes a darker color than a background color in the letter input window.

According to another embodiment, the control unit 160 can determine in block 202 whether a touch is inputted before one of the displayed letters. If the touch is inputted, the control unit 160 can control the display unit 142 to display the cursor at the touch position in the block 203. In addition, if the touch is continued more than the given time in block 204, the control unit 160 can control the display unit 142 to change the line-like cursor into the block-like cursor in block 205.

Next, by controlling the touch sensor unit 141, the control unit 160 determines whether a drag is inputted along at least one of the displayed letters (block 206). Specifically, when the line-like cursor is touched by a user and then changed into the block-like cursor, a user can input a drag in the direction of letter arrangement. Namely, if the block-like cursor is overlapped with the letter in block 205, a user inputs the drag along at least one letter including the letter overlapped with the block-like cursor. Then the touch sensor unit 141 creates a touch signal along a drag path and then sends it to the control unit 160. By receiving the touch signal, the control unit 160 finds the drag path and letters contained in the drag path.

If it is determined in block 206 that the drag is inputted, the control unit 160 controls the display unit 142 to change a graphic representation of the letters in the drag path (block 207). For example, the control unit 160 can control the display unit 142 to give a shaded or highlighted block effect to the letters in the drag path. Alternatively, the control unit 160 can control the display unit 142 to give an opposite-colored block effect to the letters in the drag path. Stage [c] of FIG. 3 shows an example user's drag gesture starting from a selected letter ‘l’, and stage [d] shows an example changed graphic representation of letters ‘love’ contained in the drag path. In stage [d], the letters ‘love’ in the drag path are emphasized by a block 305 having a darker color than a background color in the letter input window.

Thereafter, if a user releases the touch from the touch screen 140, the control unit 160 detects a user's touch release through the touch sensor unit 142 (block 208). Next, by controlling the touch sensor unit 141, the control unit 160 determines whether a tap is inputted at a certain position in the letter input window (block 209). Namely, after a drag is inputted, a user releases the touch from the end of the drag and then inputs a tap at a desired position to which the letters selected by the drag will be moved. If the tap is inputted, the control unit 160 controls the display unit 142 to display the line-like cursor at the tap position (block 210). Stage [d] of FIG. 3 shows that a user taps a position after the last letter ‘a.’ in the letter input window. Stage [e] of FIG. 3 shows that the line-like cursor is moved to a tap position in response to a user's tap input. In stage [e], the block 305 indicating the letters ‘love’ selected by the drag input remains displayed.

Next, by controlling the touch sensor unit 141, the control unit 160 determines whether a user's tap is inputted at a cursor position (block 211). If there is a tap input at the cursor position, the control unit 160 controls the display unit 142 to cut the selected letters and then paste them onto the cursor position (block 212). Here, a graphic effect of the cut and pasted letters is removed. For example, a block overlapped with the selected letters is removed after a cut and paste. According to another embodiment, in block 211, the control unit 160 can determine whether a double tap is inputted at the cursor position. Alternatively, the control unit 160 may determine whether three or more taps are inputted at the cursor position.

If there is no tap input at the cursor position, the control unit 160 further determines whether a user's tap is inputted at the selected letters by controlling the touch sensor unit 141 (block 213). For example, if a block is overlapped with the selected letters, the control unit 160 can determine whether the tap is inputted at the block. If there is a tap input at the selected letters, the control unit 160 controls the display unit 142 to remove a graphic effect of the selected letters without changing the arrangement of the displayed letters (block 214). For example, if a block is overlapped with the selected letters, the control unit 160 may remove the block from the selected letters. According to another embodiment, the control unit 160 can determine whether a user's tap is inputted at some position other than the cursor position in the block 213 and then can perform block 214.

Stage [f] of FIG. 3 shows an example screen after a user inputs a tap at the cursor position. In this stage [f], the selected letters ‘love’ are cut and pasted onto the cursor position, and the block is removed from the selected letters. Stage [g] shows an example screen after a user inputs a tap at the block overlapped with the selected letters ‘love’. In stage [g], the block is removed from the selected letters ‘love’ and thereby an original sentence (‘We love Korea.’) remains unchanged. In addition, in stage [g], the line-like cursor is located at the tap position.

According to another embodiment, if a user's tap is inputted at a certain position in the letter input window in block 209, the control unit 160 can directly perform the block 212 without performing blocks 210 and 211. Alternatively, if a double tap is inputted at a certain position in the letter input window in block 209, the control unit 160 can directly perform block 212 without performing blocks 210 and 211.

As discussed in the first embodiment, a user of the mobile device 100 can cut and paste the inputted letter(s) through a series of touch-based inputs in the letter input window. This may reduce user's inconvenience, when a user wants to change an arrangement of letters that requires deleting inputted letters and then inputting new letters again.

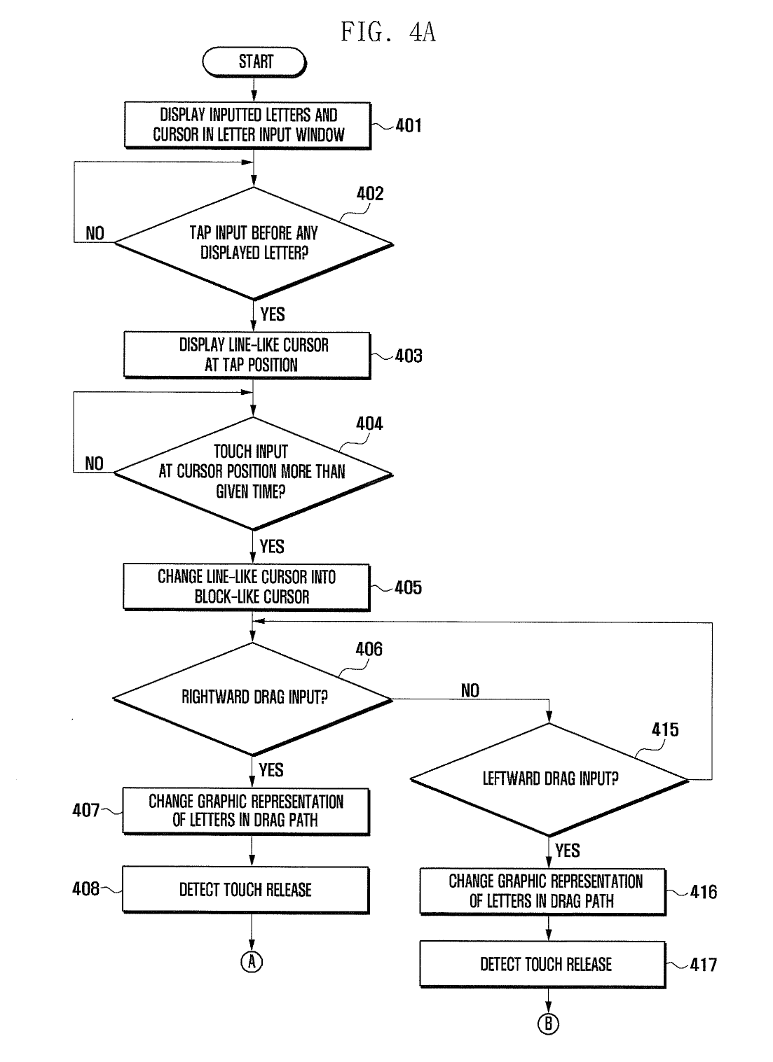

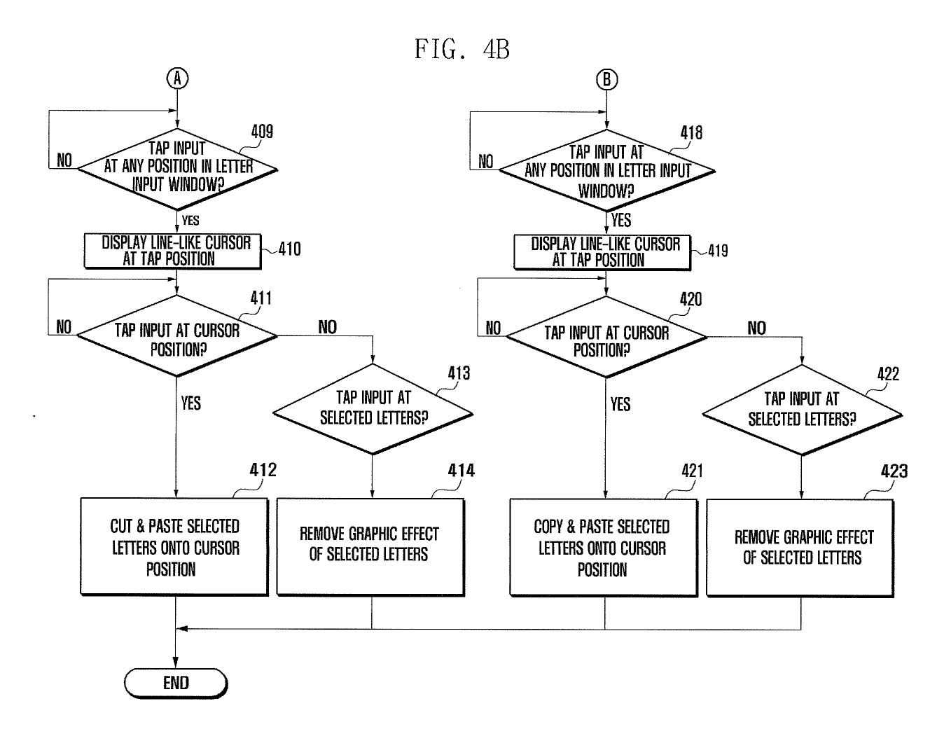

FIGS. 4A and 4B illustrate a method for inputting letters in the mobile device in accordance with a second exemplary embodiment of the present invention. The second embodiment of this invention relates to a method for transferring or repeatedly inputting the inputted letter(s) to other input position based on a cut and paste or copy and paste technique.

Blocks 401 to 405 in FIG. 4A are the same as blocks 201 to 205 in FIG. 2A. Therefore, descriptions of the blocks 401 to 405 are omitted herein.

Referring to FIGS. 4A and 4B, by controlling the touch sensor unit 141, the control unit 160 determines whether a rightward drag is inputted (block 406). In the second embodiment, the control unit 160 identifies the direction of a drag through a touch signal received from the touch sensor unit 141 and then performs different functions according to the direction of the drag. Although a rightward drag and a leftward drag are described in the second embodiment, this is for example only and should not to be considered as a limitation of the present invention. Any other directional drags may be alternatively applied to the second embodiment.

If the rightward drag is inputted, the control unit 160 performs blocks 407 to 414, which are the same as blocks 207 to 214 in FIGS. 2A and 2B. Therefore, descriptions of the blocks 407 to 414 are omitted herein. Briefly, if a user inputs the rightward drag and then releases a touch, the control unit 160 finds letters contained in a drag path, cuts them, and pastes them onto other position selected by a user.

If it is determined in block 406 that the rightward drag is not inputted, the control unit 160 further determines whether a leftward drag is inputted (block 415). If the leftward drag is inputted, the control unit 160 performs blocks 416 to 420, which are the same as blocks 207 to 211 in FIGS. 2A and 2B. Therefore, descriptions of the blocks 416 to 420 are omitted herein.

If it is determined in block 420 that there is a tap input at the cursor position, the control unit 160 controls the display unit 142 to copy the selected letters and then pastes them onto the cursor position (block 421). Namely, the control unit 160 controls the display unit 142 to display the letters selected by a user's drag input at the cursor position without removing the selected letters from the original position. Here, a graphic effect of the selected letters is removed.

If it is determined in block 420 that there is no tap input at the cursor position, the control unit 160 performs blocks 422 and 423, which are the same as blocks 213 and 214 in FIG. 2B. Therefore, descriptions of blocks 422 and 423 are omitted herein.

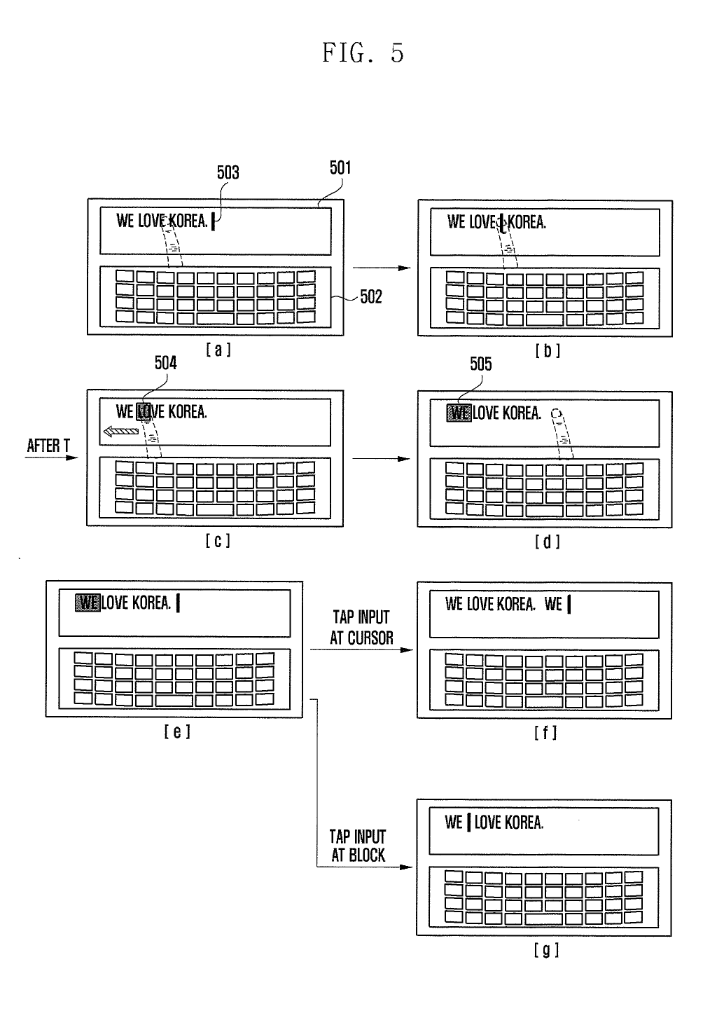

FIG. 5 illustrates screen views for the letter input method in accordance with the second exemplary embodiment of the present invention.

Stage [a] of FIG. 5 shows an example screen that is composed of the letter input window 501, the letter keys 502 and the line-like cursor 503. Stage [a] further shows that the screen displays a set of letters inputted by a user (for example, a sentence ‘We love Korea.’). In addition, a user inputs a tap before a displayed letter ‘l’ in the letter input window 501.

Stage [b] of FIG. 5 shows an example screen in which the cursor is moved before the letter ‘l’ in response to a user's tap input. Also, stage [b] further shows that a user touches the moved cursor located before the selected letter ‘l’.

Stage [c] of FIG. 5 shows an example screen after a user touches the cursor position more than the given time (T) in stage [b]. In stage [c], the block-like cursor 504 is overlapped with the selected letter ‘l’ and includes a darker color than a background color in the letter input window. In addition, stage [c] further shows a user's drag input that starts from a selected letter ‘l’, travels leftward, and selects in the end the letters ‘We’.

Stage [d] of FIG. 5 shows an example changed graphic representation of the letters ‘We’ contained in the drag path. In stage [d], the letters ‘We’ in the drag path are emphasized by a block 505 having a darker color than a background color in the letter input window. Also, stage [d] further shows that a user taps a position after the last letter ‘a.’ in the letter input window.

Stage [e] of FIG. 5 shows that the line-like cursor is moved to a tap position in response to a user's tap input. In stage [e], block 505 indicates that the letters ‘We’ selected by the drag input remains displayed.

Stage [f] of FIG. 5 shows an example screen after a user inputs a tap at the cursor position. In stage [f], the selected letters ‘We’ are copied and pasted onto the cursor position, and the block is removed from the selected letters.

Stage [g] of FIG. 5 shows an example screen after a user inputs a tap at the block overlapped with the selected letters ‘We’. In stage [g], the block is removed from the selected letters ‘We’ and thereby an original sentence (‘We love Korea.’) remains unchanged. In addition, in stage [g], the line-like cursor is located at the tap position.

As discussed above, this invention is not limited to the rightward or leftward drag, and therefore any other directional drags may be alternatively applied to this invention.

As discussed in the second embodiment of this invention, a user of the mobile device 100 can cut or copy and paste the inputted letter(s) through a series of touch-based inputs, including different directional drag inputs, in the letter input window. When a user wants to change an arrangement of inputted letters or to repeatedly input some of them, this may reduce user's inconvenience that requires inputting again new letters.

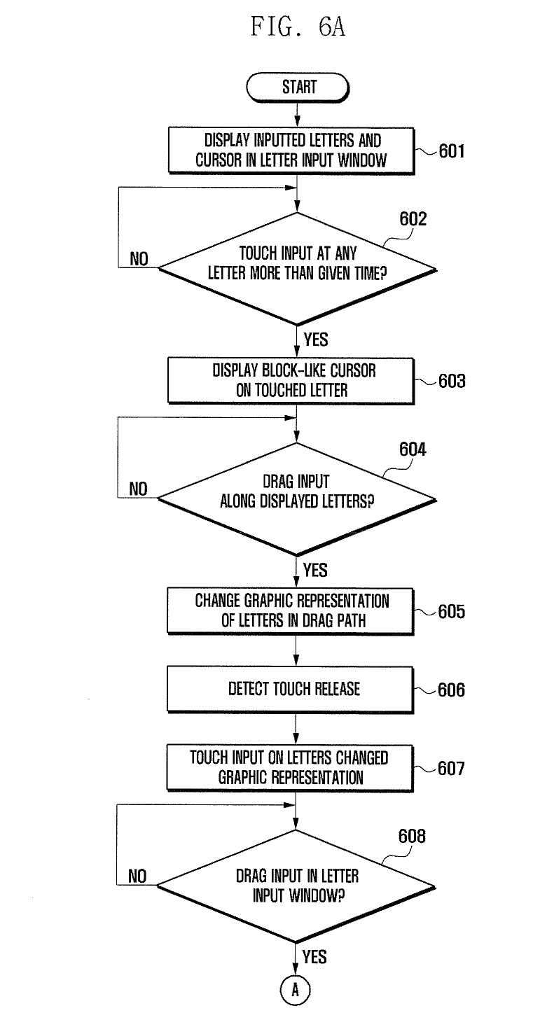

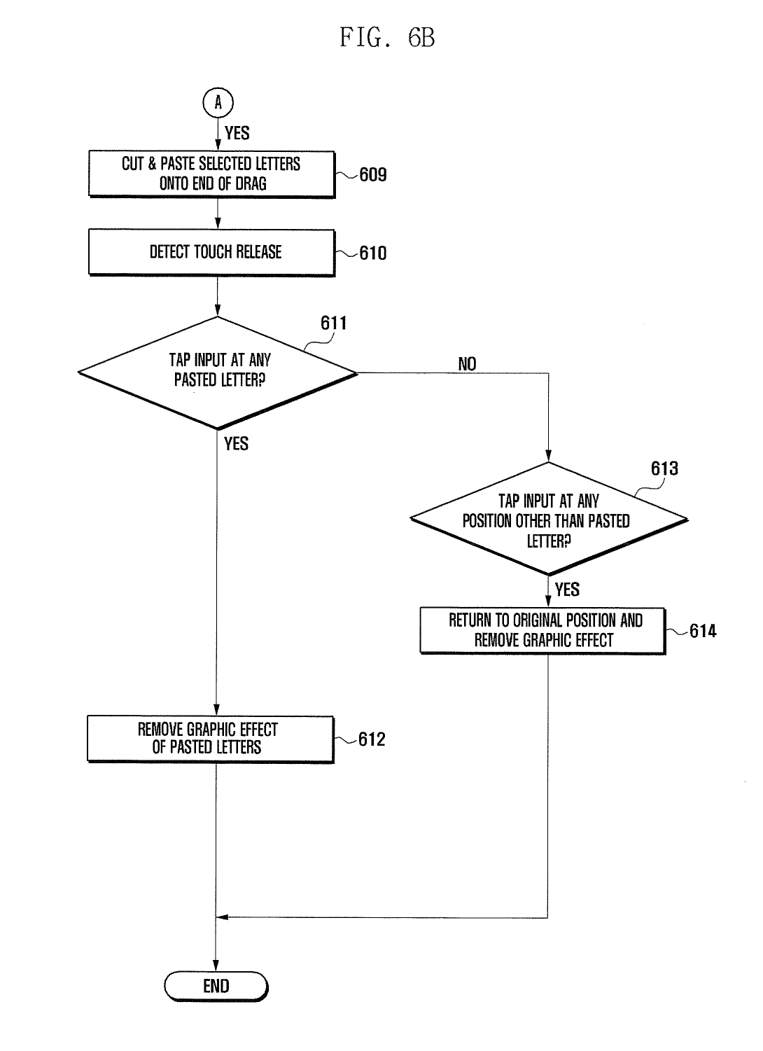

FIGS. 6A and 6B illustrate a method for inputting letters in the mobile device in accordance with the third exemplary embodiment of the present invention. The third embodiment of this invention relates to a method for transferring the inputted letter(s) to other input position, based on a cut and paste technique.

Block 601 in FIG. 6A is the same as block 201 in FIG. 2A. Therefore, a description of block 601 is omitted herein. Briefly, in block 601, the control unit 160 controls the display unit 142 to display a cursor as well as letters inputted by a user in a letter input window. The cursor is located after the last letter.

Referring to FIGS. 6A and 6B, by controlling the touch sensor unit 141, the control unit 160 determines whether a user's touch is inputted at one of the displayed letters more than a given time (block 602). Specifically, if a user touches one of letters to be moved, the touch sensor unit 141 creates a touch signal and sends it to the control unit 160. Then the control unit 160 finds a touch position through the received touch signal and determines whether the touch is inputted more than the given time. If the touch is inputted more than the given time, the control unit 160 controls the display unit 142 to change the line-like cursor into a block-like cursor (block 603). The block-like cursor may be square in shape and usually have a darker color than a background color in the letter input window. In addition, a letter overlapped with the block-like cursor may be displayed to have an opposite color.

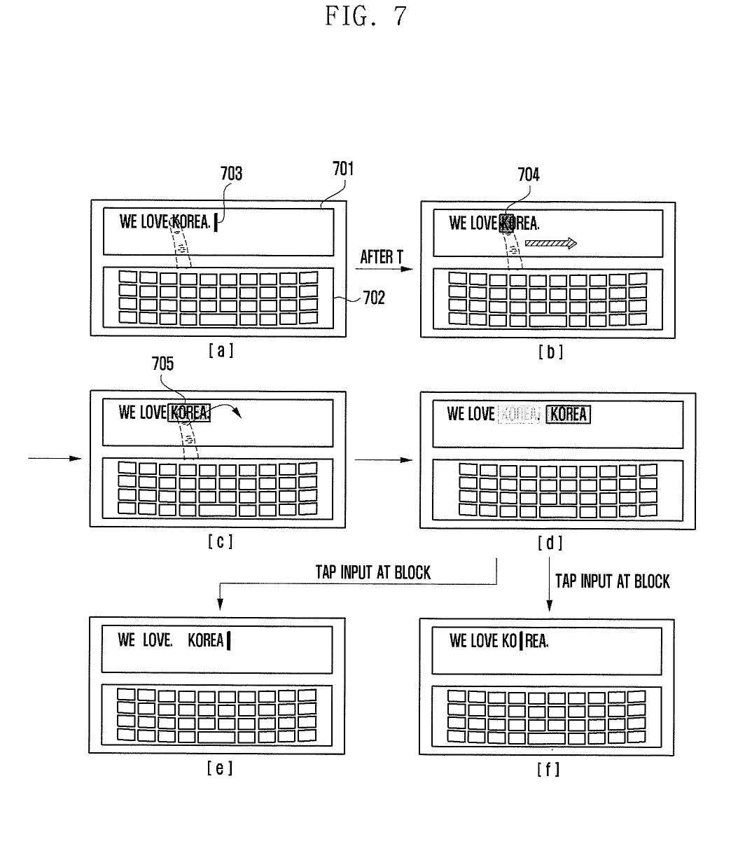

FIG. 7 illustrates screen views for the letter input method in accordance with the third exemplary embodiment of the present invention.

Stage [a] of FIG. 7 shows an example screen that is composed of the letter input window 701, the letter keys 702 and the line-like cursor 703. Stage [a] further shows that the screen displays a set of letters inputted by a user (for example, a sentence ‘We love Korea.’). In stage [a], the cursor 703 is located at the last position of the sentence. In addition, a user inputs a touch at a displayed letter ‘l’ in the letter input window 501.

Stage [b] of FIG. 7 shows an example screen after a user maintains a touch input more than a given time (T) in stage [a]. In stage [b], the block-like cursor 704 is overlapped with the touched letter ‘l’ and has a darker color than a background color in the letter input window.

Returning to FIGS. 6A and 6B, by controlling the touch sensor unit 141, the control unit 160 determines whether a drag is inputted along at least one of the displayed letters (block 604). Specifically, when the line-like cursor is touched by a user and then changed into the block-like cursor, a user inputs a drag in the direction of letter arrangement. Then the touch sensor unit 141 creates a touch signal along a drag path and then sends it to the control unit 160. By receiving the touch signal, the control unit 160 finds the drag path and letters contained in the drag path.

If the drag is inputted along at least one letter, the control unit 160 controls the display unit 142 to change a graphic representation of the letters in the drag path (block 605). For example, the control unit 160 may control the display unit 142 to give a shaded or highlighted block effect to the letters in the drag path. Alternatively, the control unit 160 may control the display unit 142 to give an opposite-colored block effect to the letters in the drag path. Stage [b] of FIG. 7 shows an example user's drag gesture starting from a selected letter ‘l’, and stage [c] of FIG. 7 shows an example changed graphic representation of letters ‘love’ contained in the drag path. In stage [c], the letters ‘love’ in the drag path are emphasized by a block 705 having a darker color than a background color in the letter input window.

Thereafter, if a user releases the touch from the touch screen 140, the control unit 160 detects a user's touch release through the touch sensor unit 142 (block 606). Then, by controlling the touch sensor unit 142, the control unit 160 detects a touch input on the letters with a changed graphic representation (block 607). Namely, in order to move the selected letters, a user touches again the selected letters. Here, the control unit 160 detects a user's touch input on the selected letters through the touch sensor unit 142.

Next, by controlling the touch sensor unit 141, the control unit 160 determines whether a drag is inputted at a certain position in the letter input window (block 608). Namely, a user touches the selected letters and then moves a touch position to a desired position. When there is a user's drag, the touch sensor unit 141 creates a touch signal along a drag path and then sends it to the control unit 160. By receiving the touch signal, the control unit 160 finds the drag path and the end position of the drag path. Then the control unit 160 controls the display unit 142 to move the selected letters with a changed graphic representation to the end position of the drag path (block 609). In some embodiment, the control unit 160 may control the display unit 142 to give a dimmed effect to an original position of the selected letters. Next, if a user releases the touch from the touch screen 140, the control unit 160 detects a user's touch release through the touch sensor unit 142 (block 610).

Stage [c] of FIG. 7 shows that a user touches the block 705 around the selected letters ‘love’ and then inputs a drag to a position after the last letter ‘a.’. Stage [d] of FIG. 7 shows the moved block. In stage [d], the original position of the moved letters ‘love’ is expressed with a block and dimmed effect.

Next, by controlling the touch sensor unit 141, the control unit 160 determines whether a user's tap is inputted at the moved letters (block 611). If there is a tap input at the moved letters, the control unit 160 controls the display unit 142 to remove a graphic effect of the moved letters (block 612). For example, a block overlapped with the selected letters is removed after a cut and paste. According to another embodiment, in the block 611, the control unit 160 can determine whether a double tap is inputted at the moved letters. Alternatively, the control unit 160 can determine whether three or more taps are inputted at the moved letters.

If there is no tap input at the moved letters, the control unit 160 further determines whether a user's tap is inputted at some position other than the moved letters by controlling the touch sensor unit 141 (block 613). If there is a tap input at some position other than the moved letters, the control unit 160 controls the display unit 142 to return the moved letters to the original position and also to remove a graphic effect of the returned letters (block 614).

Stage [e] of FIG. 7 shows an example screen after a user inputs a tap at a block around the moved letters ‘love’ in stage [d]. In stage [e], the moved letters ‘love’ are displayed without the block. Meanwhile, the dimmed letters ‘love’ in stage [d] are removed from the stage [e]. Stage [f] of FIG. 7 shows an example screen after a user inputs a tap at a block around the dimmed letters ‘love’ in stage [d]. In stage [f], all of the moved letters and their block are removed and also the dimmed letters are displayed without the block and dimmed effect. Namely, an original sentence (‘We love Korea.’) appears again. Also, in stage [f], the line-like cursor is located at the tap position.

According to another embodiment, if a user's tap is inputted at a certain position in the letter input window in the block 608, the control unit 160 can perform block 609 and then perform block 612 without performing blocks 610 and 611. Additionally, the control unit 160 can determine whether there is a double tap in the block 611 or 613 instead of the aforesaid single tap.

According to yet another embodiment, in block 604, the control unit 160 can identify the direction of a drag and then perform different functions according to the direction of the drag. Specifically, in case of a rightward drag, the control unit 160 can control the display unit 142 to cut the selected letters and then paste them onto the end position of the drag. In case of a leftward drag, the control unit 160 can control the display unit 142 to copy the selected letters and then paste them onto the end position of the drag.

As discussed in the third embodiment, a user of the mobile device 100 can cut and paste the inputted letter(s) through a series of touch-based inputs in the letter input window. When a user wants to change an arrangement of letters, this may reduce user's inconvenience that requires to delete inputted letters and then to input again new letters.

Now, a method for a letter input applied to a mobile device which is not based on a touch screen is described. Such a mobile device includes the display unit 142 and the key input unit 150. In addition, the display unit 142 displays the letter input window, the inputted letters and the cursor. The key input unit 150 has a number of input keys for inputting letters and for moving the cursor.

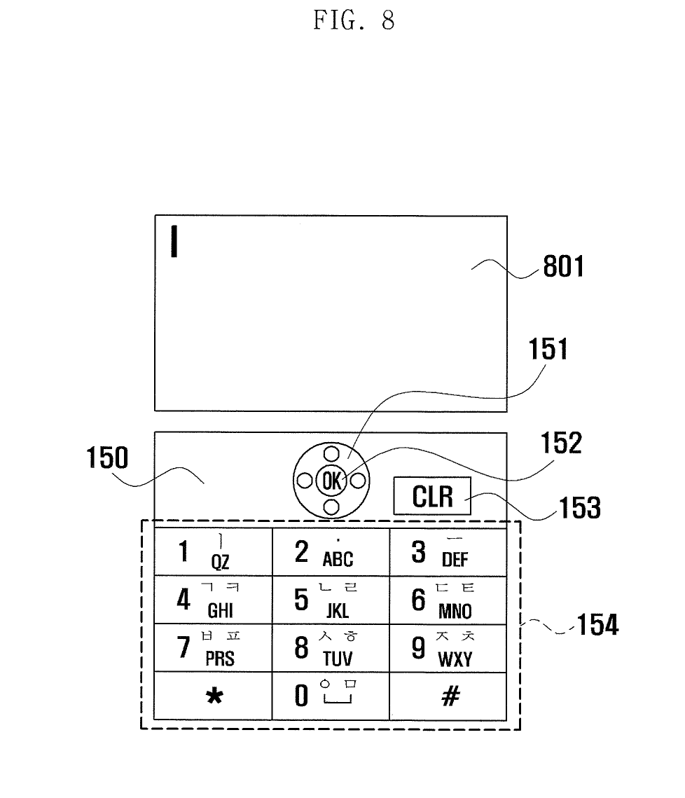

FIG. 8 illustrates a mobile device not based on a touch screen. As shown in FIG. 8, the mobile device includes the key input unit 150 and the display unit (142 shown in FIG. 1) on which the letter input window 801 is displayed. The key input unit 150 includes a navigation key 151, an OK key 152, a clear key 153 and a keypad 154 with a 3*4 key arrangement. Alternatively, the keypad 154 may have a QWERTY key arrangement. This mobile device will be applied to the fourth to seventh embodiments to be described hereinafter.

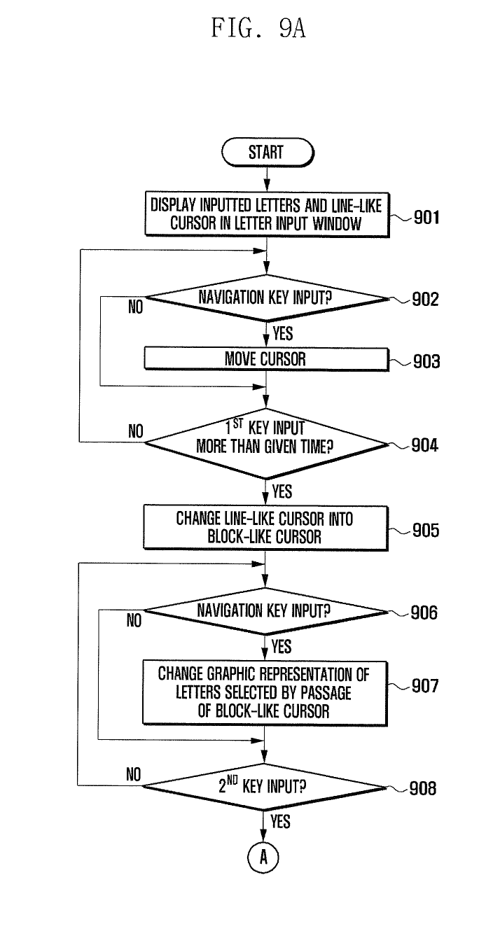

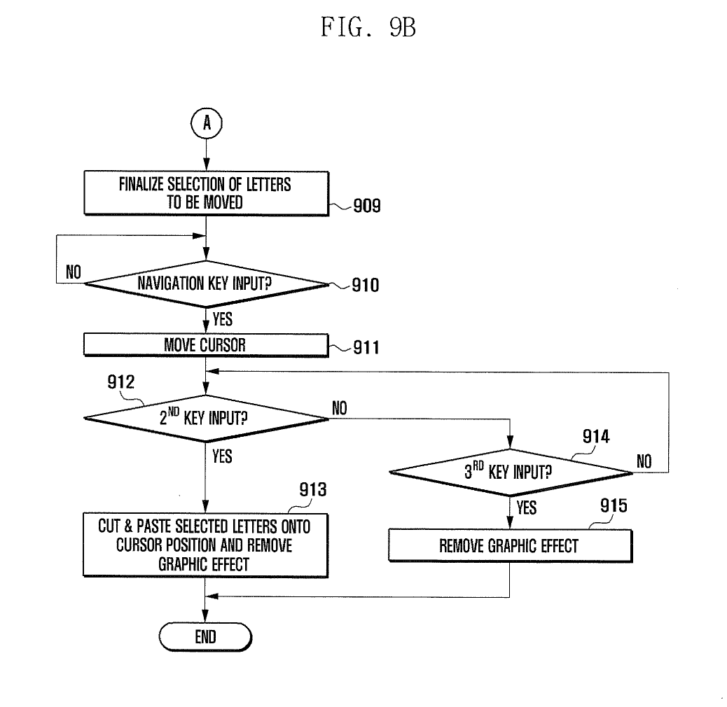

FIGS. 9A and 9B illustrate a method for inputting letters in the mobile device in accordance with the fourth exemplary embodiment of the present invention. The fourth embodiment of this invention relates to a method for transferring the inputted letter(s) to other input position, based on a cut and paste technique.

Referring to FIGS. 9A and 9B, the control unit 160 controls the display unit 142 to display letters inputted by a user and a line-like cursor in the letter input window 801 (block 901). Specifically, when a user presses one of the keys arranged in the keypad 154 of the key input unit 150, the control unit 160 finds an inputted key from the pressed key and controls the display unit 142 to display a letter corresponding to the inputted key and also to display the line-like cursor at the next input position.

Next, the control unit 160 determines whether the navigation key 151 of the key input unit 150 is inputted (block 902). Here, an input of the navigation key corresponds to an input for moving the cursor. Normally the navigation key has four (namely, rightward, leftward, upward and downward) directions. The control unit 160 can find a selected direction from the input of the navigation key.

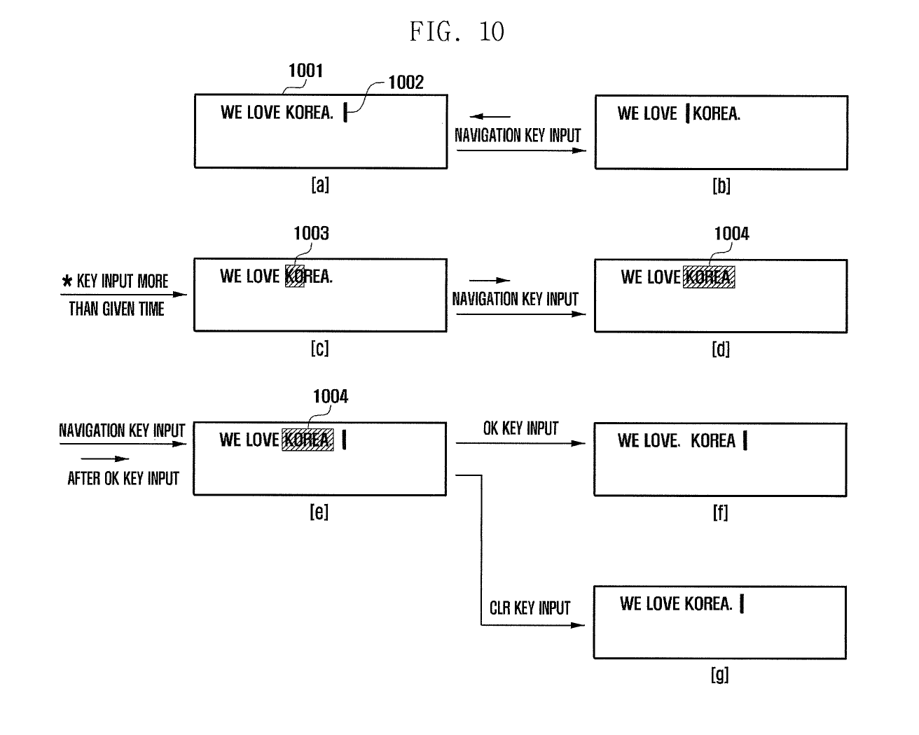

FIG. 10 illustrates screen views for the letter input method in accordance with the fourth exemplary embodiment of the present invention.

Stage [a] of FIG. 10 shows the line-like cursor 1002 and the letter input window 1001 in which a set of letters inputted by a user (for example, a sentence ‘We love Korea.’) is displayed. In stage [a], the line-like cursor 1002 is located at the last position of the sentence.

Returning to FIGS. 9A and 9B, if it is determined in the block 902 that the navigation key is inputted, the control unit 160 controls the display unit 142 to move the cursor 1002 depending on the input direction and number of the navigation key (block 903). For example, if a user presses the rightward navigation key five times, the cursor moves five times in the rightward direction on the display unit 142 under the control of the control unit 160.

Stage [b] of FIG. 10 shows the cursor moved in response to eleven inputs of the leftward navigation key in the stage [a]. In stage [b], the cursor is located before a letter ‘l’.

Next, the control unit 160 determines whether the first key of the key input unit 150 is inputted more than a given time (block 904). In this embodiment, the first key is used to enter into a mode for selecting letters to be moved. The first key may be predefined among keys of the key input unit 150. Preferably, the first key may be some key other than the navigation key, the OK key and the clear key. Namely, the first key may be one of keys arranged in the keypad.

If the first key is inputted more than the given time, the control unit 160 controls the display unit 142 to change the line-like cursor into a block-like cursor (block 905). The block-like cursor may be square in shape and usually have a darker color than a background color in the letter input window. Also, a letter overlapped with the block-like cursor may be displayed to have an opposite color.

Stage [c] of FIG. 10 shows an example screen after a user presses the first key (e.g., an asterisk (*) key) more than the given time in the stage [b]. In stage [c], the block-like cursor 1003 is overlapped with the selected letter ‘l’ and has a darker color than a background color in the letter input window.

Next, the control unit 160 determines whether the navigation key of the key input unit 150 is inputted (block 906). Here, an input of the navigation key corresponds to an input for selecting letters to be moved. If the navigation key is inputted, the control unit 160 controls the display unit 142 to change a graphic representation of the letters selected by the passage of the block-like cursor (block 907). For example, the control unit 160 may control the display unit 142 to give a shaded or highlighted block effect to the selected letters. Alternatively, the control unit 160 can control the display unit 142 to give an opposite-colored block effect to the letters in the drag path. In block 907, the control unit 160 recognizes the selected letters as letters to be moved.

Stage [d] of FIG. 10 shows an example changed graphic representation of the selected letters ‘love’ when a user presses the rightward navigation key three times in the stage [c]. In stage [d], the selected letters ‘love’ are emphasized by a block 1004 having a darker color than a background color in the letter input window.

Next, the control unit 160 determines whether the second key of the key input unit 150 is inputted (block 908). In this embodiment, the second key is used to finalize the selection of letters to be moved or used to execute the movement of the selected letters. In block 908, the second key is used for the former purpose. The second key may be predefined among keys of the key input unit 150. Preferably, the second key may be the OK key or one of alphanumeric keys arranged in the keypad.

If the second key is inputted, the control unit 160 finalizes the selection of letters to be moved (block 909). In stage [d], the control unit 160 determines to move the selected letters ‘love’.

Next, the control unit 160 determines whether the navigation key is inputted (block 910). Here, a user presses the navigation key in order to select a certain position to which the selected letters will be moved. Namely, an input of the navigation key in this step corresponds to an input for selecting a destination of the selected letters. If the navigation key is inputted, the control unit 160 controls the display unit 142 to move the cursor depending on the input direction and number of the navigation key (block 911).

Stage [e] of FIG. 10 shows the cursor moved when a user presses the rightward navigation key seven times after pressing the OK key in the stage [d]. In stage [e], the block indicating the selected letters ‘love’ remains displayed.

Next, the control unit 160 determines whether the second key of the key input unit 150 is inputted (block 912). In block 912, the second key is used to execute the movement of the selected letters.

If the second key is inputted, the control unit 160 controls the display unit 142 to cut the selected letters and then paste them onto the cursor position (block 913). In block 913, a graphic effect of the cut and pasted letters is removed. For example, a block overlapped with the selected letters is removed after a cut and paste. Stage [f] of FIG. 10 shows an example screen after a user presses the OK key in the stage [e]. In stage [f], the selected letters ‘love’ are cut and pasted onto the cursor position, and the block is removed from the selected letters.

If the second key is not inputted in block 912, the control unit 160 further determines whether the third key of the key input unit 150 is inputted (block 914). In this embodiment, the third key is used to release the selection of the letters. The third key may be predefined among keys of the key input unit 150. Preferably, the third key may be the clear key or one of alphanumeric keys arranged in the keypad.

If the third key is inputted, the control unit 160 controls the display unit 142 to remove a graphic effect of the selected letters without changing the arrangement of the displayed letters (block 915). For example, if a block is overlapped with the selected letters, the control unit 160 can remove the block from the selected letters.

Stage [g] of FIG. 10 shows an example screen after a user presses the clear key in stage [e]. In stage [g], the block is removed from the selected letters ‘love’ and thereby an original sentence (‘We love Korea.’) remains unchanged. In addition, in stage [g], the line-like cursor is located at the same position.

According to the above discussion, the fourth embodiment employs the first, second and third keys as function keys. Alternatively, this embodiment may use the first key only.

According to another embodiment, the control unit 160 may determine whether the first key, not the second key, of the key input unit 150 is inputted more than a given time in block 908. Namely, an input of the first key more than the given time may be considered as an input to finalize the selection of letters to be moved as well as an input to enter into a mode for selecting letters to be moved.

Additionally, in block 912, the control unit 160 may determine whether the first key, not the second key, of the key input unit 150 is inputted more than a given time. Namely, an input of the first key more than the given time may be considered as an input to execute the movement of the selected letters. In addition, in block 914, the control unit 160 may determine whether the first key, not the third key, of the key input unit 150 is inputted. Here, an input of the first key less than a given time may be considered as an input to release the selection of the letters.

According to the above discussion, the fourth embodiment is based on a cut and paste process. Alternatively, this embodiment may be based on a copy and paste process. In this case, the control unit 160 may control the display unit 142 to copy the selected letters and then paste them onto the cursor position in block 913.

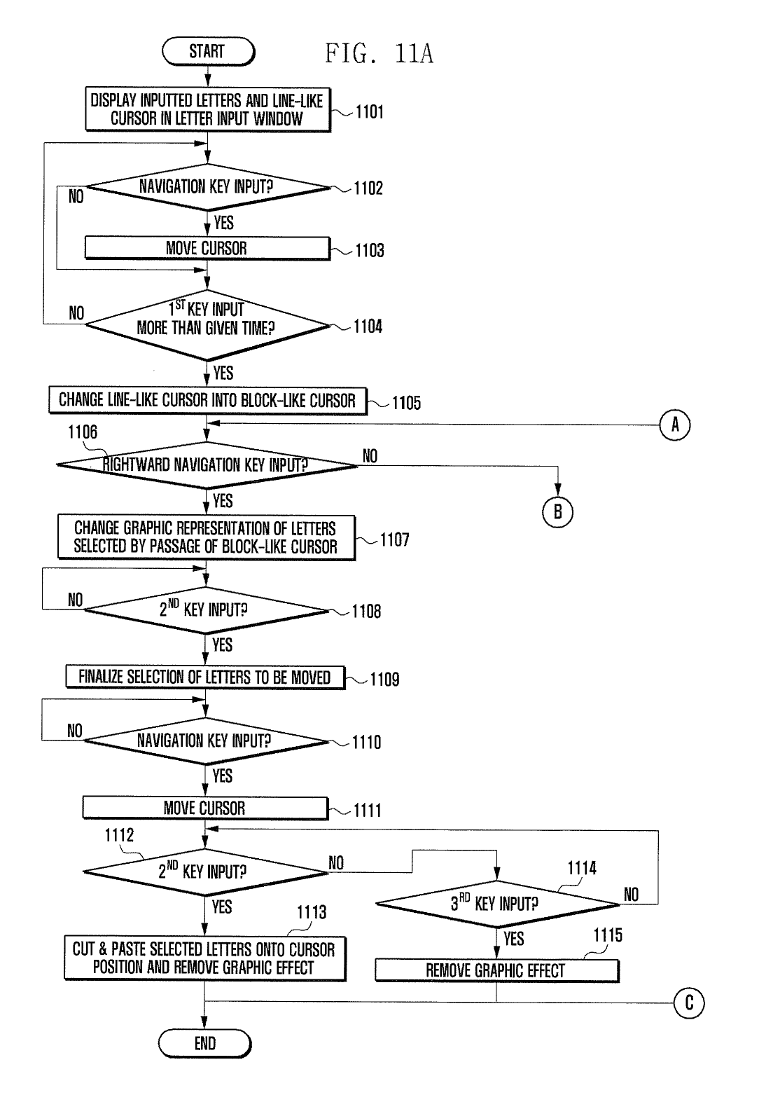

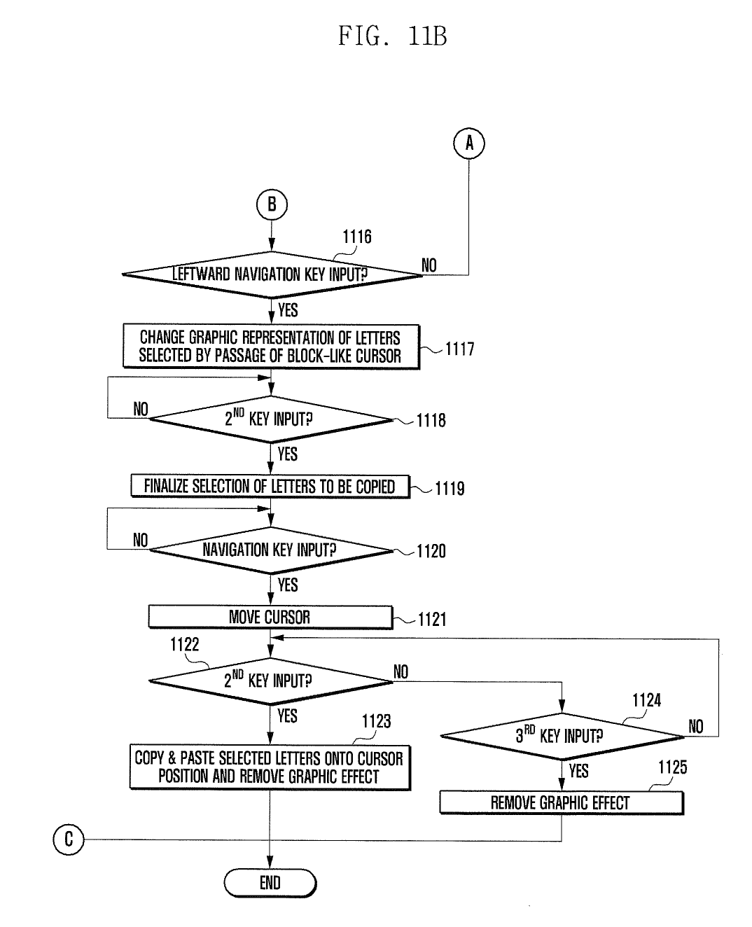

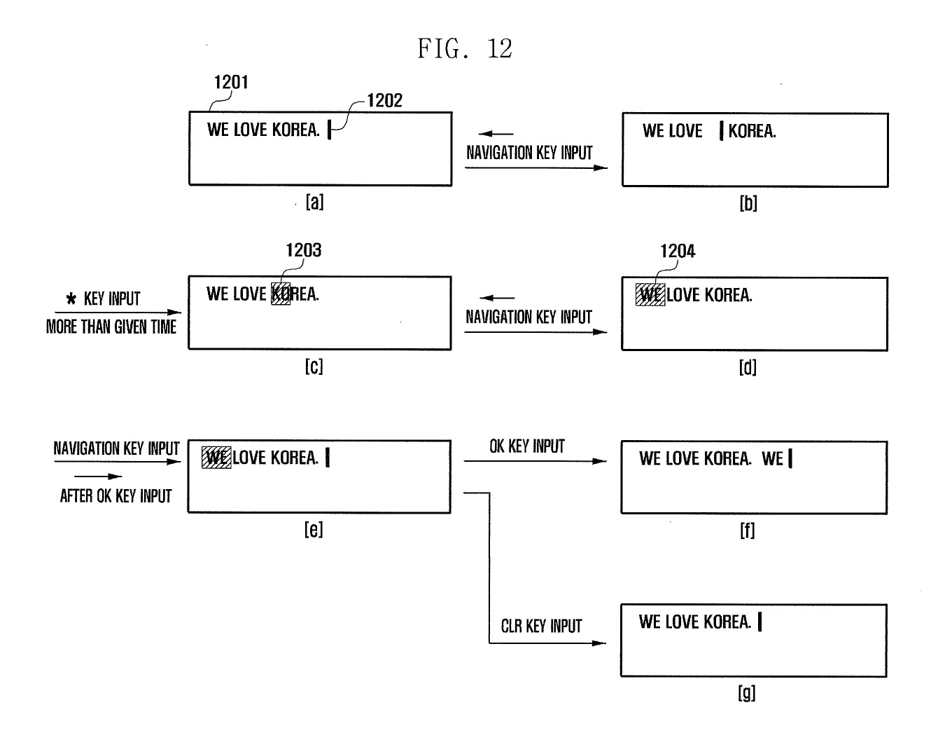

FIGS. 11A and 11B are a flow diagram illustrating a method for inputting letters in the mobile device in accordance with the fifth exemplary embodiment of the present invention. FIG. 12 is a screen view illustrating the letter input method in accordance with the fifth exemplary embodiment of the present invention.

The fifth embodiment of this invention relates to a method for transferring or repeatedly inputting the inputted letter(s) to other input position, based on a cut and paste or copy and paste technique.

Blocks 1101 to 1105 in FIG. 11A are the same as blocks 901 to 905 in FIG. 9A. Therefore, descriptions of blocks 1101 to 1105 are omitted herein. Additionally, stages [a] to [c] of FIG. 12 are the same as stages [a] to [c] of FIG. 10. Therefore, their descriptions are also omitted herein.

Referring to FIGS. 11A and 11B, the control unit 160 determines whether the rightward navigation key of the key input unit 150 is inputted (block 1106). Here, an input of the rightward navigation key corresponds to an input for selecting letters to be moved. If the rightward navigation key is inputted, the control unit 160 controls the display unit 142 to change a graphic representation of the letters selected by the passage of the block-like cursor (block 1107). In block 1107, the control unit 160 recognizes the selected letters as letters to be moved.

Next, the control unit 160 determines whether the second key of the key input unit 150 is inputted (block 1108). In this embodiment, the second key is used to finalize the selection of letters to be moved or used to execute the movement of the selected letters. In block 1108, the second key is used for the former purpose.

If the second key is inputted, the control unit 160 finalizes the selection of letters to be moved (block 1109). FIGURE discussed above may be applied to the fifth embodiment. Referring to FIG. 10, in stage [d], the control unit 160 determines to move the selected letters ‘love’.

Next, the control unit 160 determines whether the navigation key is inputted (block 1110). The navigation key inputted in block 1110 may be the rightward key or the leftward key. Here, a user presses the navigation key in order to select a certain position to which the selected letters will be moved. Namely, an input of the navigation key in this step corresponds to an input for selecting a destination of the selected letters. If the navigation key is inputted, the control unit 160 controls the display unit 142 to move the cursor depending on the input direction and number of the navigation key (block 1111). Stage [e] of FIG. 10 shows the cursor moved when a user presses the rightward navigation key seven times after pressing the OK key in the stage [d] of FIG. 10. In stage [e] of FIG. 10, the cursor is moved to the end of the displayed sentence.

Next, the control unit 160 determines whether the second key of the key input unit 150 is inputted (block 1112). In block 1112, the second key is used to execute the movement of the selected letters.

If the second key is inputted, the control unit 160 controls the display unit 142 to cut the selected letters and then paste them onto the cursor position (block 1113). In block 1113, a graphic effect of the cut and pasted letters is removed. For example, a block overlapped with the selected letters is removed after a cut and paste. Stage [f] of FIG. 10 shows a screen after a user presses the OK key in the stage [e] of FIG. 10. In stage [f] of FIG. 10, the selected letters ‘love’ are cut and pasted onto the cursor position, and the block is removed from the selected letters.

If the second key is not inputted in block 1112, the control unit 160 further determines whether the third key of the key input unit 150 is inputted (block 1114). In this embodiment, the third key is used to release the selection of the letters.

If the third key is inputted, the control unit 160 controls the display unit 142 to remove a graphic effect of the selected letters without changing the arrangement of the displayed letters (block 1115). Stage [g] of FIG. 10 shows an example screen after a user presses the clear key in the stage [e] of FIG. 10. In stage [g] of FIG. 10, the block is removed from the selected letters ‘love’ and thereby an original sentence remains unchanged.

Meanwhile, if it is determined in block 1106 that the rightward navigation key is not inputted, the control unit 160 determines whether the leftward navigation key of the key input unit 150 is inputted (block 1116). In block 1116, an input of the leftward navigation key corresponds to an input for selecting letters to be copied.

If the leftward navigation key is inputted, the control unit 160 controls the display unit 142 to change a graphic representation of the letters selected by the passage of the block-like cursor (block 1117). In block 1117, the control unit 160 recognizes the selected letters as letters to be copied.

Next, the control unit 160 determines whether the second key of the key input unit 150 is inputted (block 1118). In this embodiment, the second key is used to finalize the selection of letters to be copied or used to execute the copy of the selected letters. In block 1118, the second key is used for the former purpose.

If the second key is inputted, the control unit 160 finalizes the selection of letters to be copied (block 1119). Referring to FIG. 12, in stage [d], the control unit 160 determines to copy the selected letters ‘We’.

Next, the control unit 160 determines whether the navigation key is inputted (block 1120). The navigation key inputted in block 1120 may be the rightward key or the leftward key. Here, an input of the navigation key corresponds to an input for selecting a destination of the copied letters.

If the navigation key is inputted, the control unit 160 controls the display unit 142 to move the cursor depending on the input direction and number of the navigation key (block 1121). Stage [e] of FIG. 12 shows the cursor moved when a user presses the rightward navigation key fourteen times after pressing the OK key in stage [d] of FIG. 12. In stage [e] of FIG. 12, the cursor is located at the end of the displayed sentence.

Next, the control unit 160 determines whether the second key of the key input unit 150 is inputted (block 1122). In block 1122, the second key is used to execute the copy and paste of the selected letters.

If the second key is inputted, the control unit 160 controls the display unit 142 to copy the selected letters and then paste them onto the cursor position (block 1123). In block 1123, a graphic effect of the copied and pasted letters is removed. Stage [f] of FIG. 12 shows an example screen after a user presses the OK key in stage [e] of FIG. 12. In stage [f] of FIG. 12, the selected letters ‘We’ are copied and pasted onto the cursor position, and the block is removed from the selected letters.

If the second key is not inputted in the block 1122, the control unit 160 further determines whether the third key of the key input unit 150 is inputted (block 1124). In this embodiment, the third key is used to release the selection of the letters.

If the third key is inputted, the control unit 160 controls the display unit 142 to remove a graphic effect of the selected letters without copying the letters (block 1125). Stage [g] of FIG. 12 exemplarily shows a screen after a user presses the clear key in the stage [e] of FIG. 12. In stage [g] of FIG. 12, the block is removed from the selected letters ‘We’ and thereby an original sentence remains unchanged.

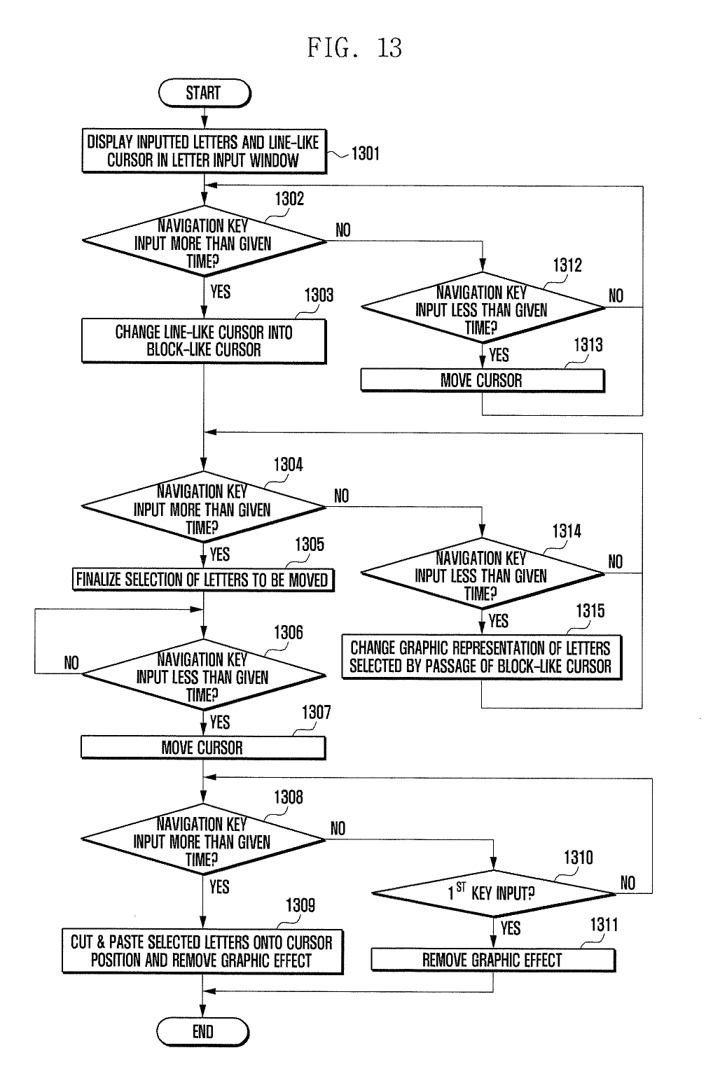

FIG. 13 illustrates a method for inputting letters in the mobile device in accordance with the sixth exemplary embodiment of the present invention. The sixth embodiment of this invention relates to a method for transferring the inputted letter(s) to other input position, based on a cut and paste technique. In particular, the sixth embodiment employs the navigation key and a single one of the function keys.

Referring to FIG. 13, the control unit 160 controls the display unit 142 to display letters inputted by a user and a line-like cursor in the letter input window (block 1301).

Next, the control unit 160 determines whether the navigation key of the key input unit 150 is inputted more than a given time (block 1302). In this embodiment, an input of the navigation key more than the given time is considered as an input to enter into a mode for selecting letters to be moved.

If the navigation key is not inputted more than the given time, the control unit 160 further determines whether the navigation key is inputted less than the given time (block 1312). In block 1312, an input of the navigation key less than the given time is considered as an input to move the cursor. If the navigation key is inputted less than the given time, the control unit 160 controls the display unit 142 to move the cursor depending on the input direction and number of the navigation key (block 1313).

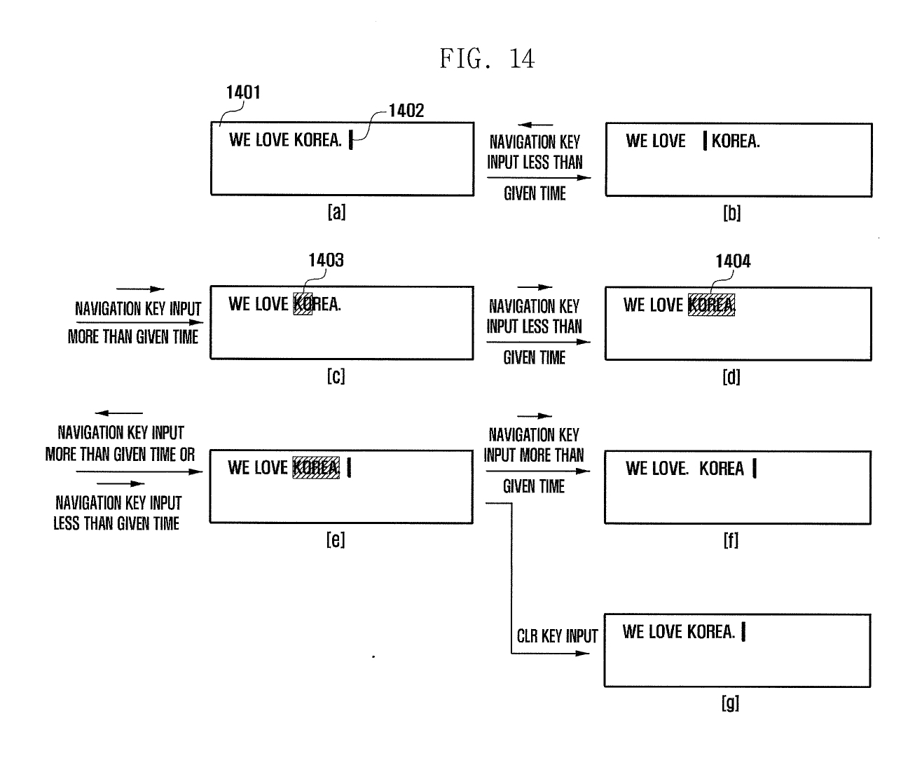

FIG. 14 illustrates screen views for the letter input method in accordance with the sixth exemplary embodiment of the present invention.

Stage [a] of FIG. 14 shows the line-like cursor 1402 and the letter input window 1401 in which a set of letters inputted by a user (for example, a sentence ‘We love Korea.’) is displayed. In stage [a], the line-like cursor 1402 is located at the end of the sentence in response to eleven inputs, each of which is less than the given time, of the leftward navigation key.

Returning to FIG. 13, if the navigation key of the key input unit 150 is inputted more than the given time in the block 1302, the control unit 160 controls the display unit 142 to change the line-like cursor into a block-like cursor (block 1303). Here, the block-like cursor may be located in the direction of the inputted navigation key. For example, if a user presses the rightward navigation key more than the given time, the block-like cursor may be located at the right of the line-like cursor.

Stage [c] of FIG. 14 exemplarily shows a screen after a user presses the rightward navigation key more than the given time in the stage [b] of FIG. 14. In stage [c], the block-like cursor 1403 is overlapped with the selected letter ‘l’.

Next, the control unit 160 determines whether the navigation key of the key input unit 150 is inputted again more than a given time (block 1304). In block 1304, an input of the navigation key more than the given time is considered as an input to finalize the selection of the letters to be moved. In some embodiment, the navigation key inputted in block 1304 may be opposite in direction to that inputted in block 1302. For example, if the rightward navigation key is inputted more than a given time in the block 1302, the control unit 160 may determine whether the leftward navigation key is inputted more than a given time in block 1304.

If the navigation key is not inputted more than the given time in block 1304, the control unit 160 further determines whether the navigation key is inputted less than the given time (block 1314). In block 1314, an input of the navigation key less than the given time is considered as an input to select the letters to be moved.

If the navigation key is inputted less than the given time, the control unit 160 controls the display unit 142 to change a graphic representation of the letters selected by the passage of the block-like cursor (block 1315). In block 1315, the control unit 160 recognizes the selected letters as letters to be moved.

Stage [d] of FIG. 14 shows an example changed graphic representation of the selected letters ‘love’ when a user presses the rightward navigation key three times in the stage [c]. In stage [d], the selected letters ‘love’ are emphasized by a block 1404.

If the navigation key is inputted more than the given time in the block 1304, the control unit 160 finalizes the selection of letters to be moved (block 1305).

Next, the control unit 160 determines whether the navigation key is inputted less than a given time (block 1306). In block 1306, an input of the navigation key less than the given time is considered as an input to select a position to which the selected letters will be moved.

If the navigation key is inputted less than the given time in block 1306, the control unit 160 controls the display unit 142 to move the cursor depending on the input direction and number of the navigation key (block 1307).

Stage [e] of FIG. 14 shows the cursor moved when a user presses the rightward navigation key seven times after pressing the leftward navigation key more than the given time in stage [d]. In stage [e], the block indicating the selected letters ‘love’ remains displayed.

Next, the control unit 160 determines whether the navigation key of the key input unit 150 is inputted more than a given time (block 1308). In block 1308, an input of the navigation key more than the given time is considered as an input to execute the movement of the selected letters.

If the navigation key is inputted more than the given time in block 1308, the control unit 160 controls the display unit 142 to cut the selected letters and then paste them onto the cursor position (block 1309). In block 1309, a graphic effect of the cut and pasted letters is removed. Stage [f] of FIG. 14 shows an example screen after a user presses the rightward navigation key more than the given time in the stage [e]. In stage [f], the selected letters ‘love’ are cut and pasted onto the cursor position.

If the navigation key is not inputted more than the given time in block 1308, the control unit 160 further determines whether the first key of the key input unit 150 is inputted (block 1310). In this embodiment, the first key is used to release the selection of the letters. The first key may be predefined among keys of the key input unit 150. Preferably, the first key may be the clear key or one of alphanumeric keys arranged in the keypad.

If the first key is inputted, the control unit 160 controls the display unit 142 to remove a graphic effect of the selected letters without changing the arrangement of the displayed letters (block 1311). Stage [g] of FIG. 14 shows an example screen after a user presses the clear key in the stage [e] of FIG. 14. In stage [g], the block is removed from the selected letters ‘love’ and thereby an original sentence (‘We love Korea.’) remains unchanged.

According to the above discussion, the sixth embodiment is based on a cut and paste process. Alternatively, this embodiment may be based on a copy and paste process.

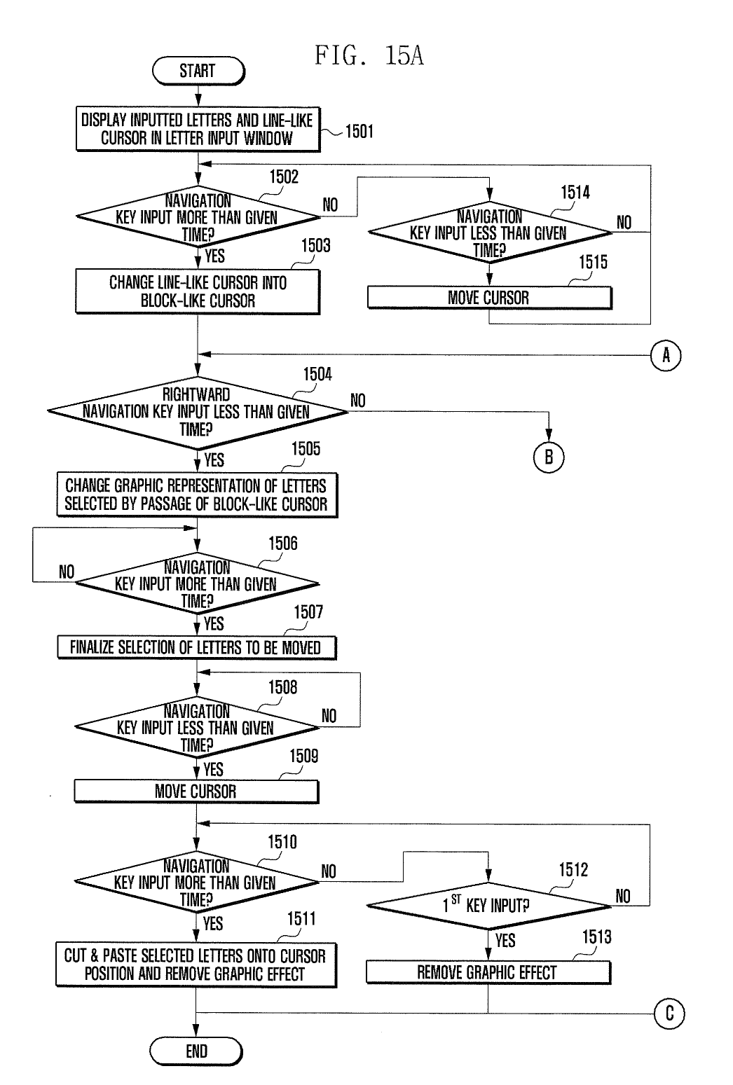

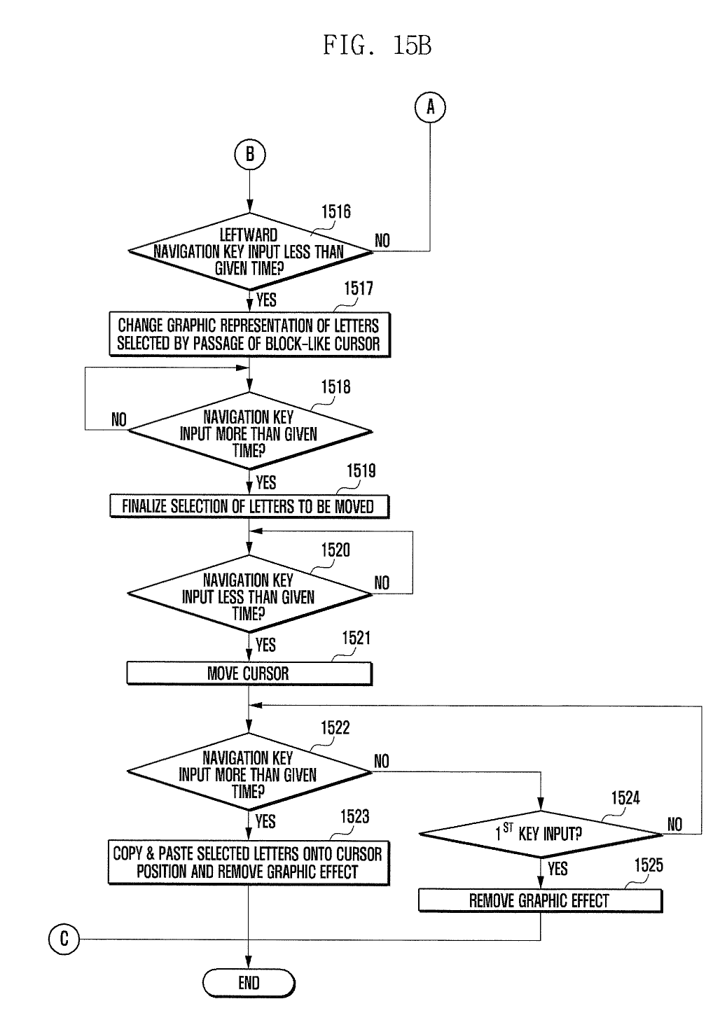

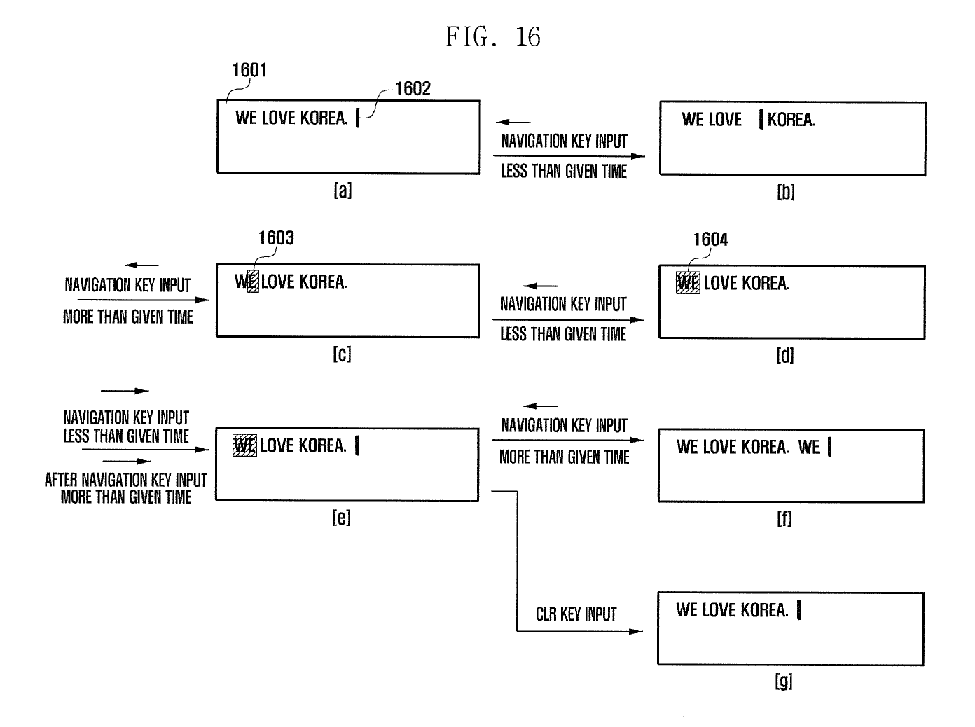

FIGS. 15A and 15B illustrate a method for inputting letters in the mobile device in accordance with the seventh exemplary embodiment of the present invention. In addition, FIGURE illustrates screen views for the letter input method in accordance with the seventh exemplary embodiment of the present invention. The seventh embodiment of this invention relates to a method for transferring or repeatedly inputting the inputted letter(s) to other input position, based on a cut and paste or copy and paste technique. In particular, the seventh embodiment employs the navigation key and a single one of the function keys. The following description will refer to FIG. 14 discussed above as well as FIGS. 15A, 15B and 16.

Blocks 1501, 1502, 1503, 1514 and 1515 in FIGS. 15A and 15B are the same as blocks 1301, 1302, 1303, 1312 and 1313 in FIG. 13, respectively. Therefore, their descriptions are omitted herein. Additionally, stages [a] and [b] of FIG. 16 are the same as stages [a] and [b] of FIG. 14. Therefore, their descriptions are also omitted herein. Stage [c] of FIG. 16 shows an example screen in case where a user presses the leftward navigation key more than a given time in order to enter into a mode for selecting letters to be copied.

The control unit 160 determines whether the rightward navigation key is inputted less than a given time (block 1504). In this embodiment, an input of the rightward navigation key less than the given time is considered as an input to select the letters to be moved. If the rightward navigation key is inputted less than the given time, the control unit 160 controls the display unit 142 to change a graphic representation of the letters selected by the passage of the block-like cursor (block 1505). Here, the control unit 160 recognizes the selected letters as letters to be moved. Stage [d] of FIG. 14 shows an example changed graphic representation of the selected letters ‘love’ when a user presses the rightward navigation key three times in the previous stage [c].

Next, the control unit 160 determines whether the navigation key of the key input unit 150 is inputted more than a given time (block 1506). In block 1506, an input of the navigation key more than the given time is considered as an input to finalize the selection of the letters to be moved. In some embodiment, the control unit 160 can determine whether the leftward navigation key is inputted more than a given time in the block 1506.

If the navigation key is inputted more than the given time in block 1506, the control unit 160 finalizes the selection of letters to be moved (block 1507).

Next, the control unit 160 determines whether the navigation key is inputted less than a given time (block 1508). In block 1508, an input of the navigation key less than the given time is considered as an input to select a position to which the selected letters will be moved.

If the navigation key is inputted less than the given time in block 1508, the control unit 160 controls the display unit 142 to move the cursor depending on the input direction and number of the navigation key (block 1509).

Stage [e] of FIG. 14 shows the cursor moved when a user presses the rightward navigation key seven times after pressing the leftward navigation key more than the given time in the stage [d] of FIG. 14. In stage [e] of FIG. 14, the block indicating the selected letters ‘love’ remains displayed.

Next, the control unit 160 determines whether the navigation key of the key input unit 150 is inputted more than a given time (block 1510). In block 1510, an input of the navigation key more than the given time is considered as an input to execute the movement of the selected letters.

If the navigation key is inputted more than the given time in block 1510, the control unit 160 controls the display unit 142 to cut the selected letters and then paste them onto the cursor position (block 1511). In block 1511, a graphic effect of the cut and pasted letters is removed. Stage [f] of FIG. 14 shows an example screen after a user presses the rightward navigation key more than the given time in stage [e] of FIG. 14. In stage [f] of FIG. 14, the selected letters ‘love’ are cut and pasted onto the cursor position.

If the navigation key is not inputted more than the given time in the block 1510, the control unit 160 further determines whether the first key of the key input unit 150 is inputted (block 1512). In this embodiment, the first key is used to release the selection of the letters.

If the first key is inputted, the control unit 160 controls the display unit 142 to remove a graphic effect of the selected letters without changing the arrangement of the displayed letters (block 1513). Stage [g] of FIG. 14 shows a screen after a user presses the clear key in stage [e] of FIG. 14. In stage [g] of FIG. 14, the block is removed from the selected letters ‘love’ and thereby an original sentence (‘We love Korea.’) remains unchanged.

If the rightward navigation key is not inputted less than the given time in block 1504, the control unit 160 further determines whether the leftward navigation key is inputted less than a given time (block 1516). In block 1516, an input of the leftward navigation key less than the given time is considered as an input to select the letters to be copied. If the leftward navigation key is inputted less than the given time, the control unit 160 controls the display unit 142 to change a graphic representation of the letters selected by the passage of the block-like cursor (block 1517). Here, the control unit 160 recognizes the selected letters as letters to be copied. Stage [d] of FIG. 16 shows an example changed graphic representation of the selected letters ‘We’ when a user presses the leftward navigation key once in the previous stage [c].

Next, the control unit 160 determines whether the navigation key of the key input unit 150 is inputted more than a given time (block 1518). In block 1518, an input of the navigation key more than the given time is considered as an input to finalize the selection of the letters to be copied. In some embodiment, the control unit 160 may determine whether the rightward navigation key is inputted more than a given time in the block 1518.

If the navigation key is inputted more than the given time in the block 1518, the control unit 160 finalizes the selection of letters to be copied (block 1519).

Next, the control unit 160 determines whether the navigation key is inputted less than a given time (block 1520). In block 1520, an input of the navigation key less than the given time is considered as an input to select a position to which the copied letters will be pasted.

If the navigation key is inputted less than the given time in the block 1520, the control unit 160 controls the display unit 142 to move the cursor depending on the input direction and number of the navigation key (block 1521). Stage [e] of FIG. 16 shows the cursor moved when a user presses the rightward navigation key fourteen times after pressing the rightward navigation key more than the given time in stage [d] of FIG. 16. In stage [e] of FIG. 16, the block indicating the selected letters ‘We’ remains displayed, and the cursor is located at the end of the displayed sentence.

Next, the control unit 160 determines whether the navigation key of the key input unit 150 is inputted more than a given time (block 1522). In block 1522, an input of the navigation key more than the given time is considered as an input to execute the copy and paste of the selected letters.

If the navigation key is inputted more than the given time in block 1522, the control unit 160 controls the display unit 142 to copy the selected letters and then paste them onto the cursor position (block 1523). In block 1523, a graphic effect of the copied and pasted letters is removed.

Stage [f] of FIG. 16 shows an example screen after a user presses the rightward navigation key more than the given time in the stage [e] of FIG. 16. In this stage [f] of FIG. 16, the selected letters ‘We’ are copied and pasted onto the cursor position.

If the navigation key is not inputted more than the given time in the block 1522, the control unit 160 further determines whether the first key of the key input unit 150 is inputted (block 1524).

If the first key is inputted, the control unit 160 controls the display unit 142 to remove a graphic effect of the selected letters without copying the letters (block 1525). Stage [g] of FIG. 16 shows an example screen after a user presses the clear key in stage [e] of FIG. 16. In stage [g] of FIG. 16, the block is removed from the selected letters ‘We’ and thereby an original sentence remains unchanged.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for inputting a letter in a mobile device, the method comprising:
displaying letters inputted by a user in a letter input window;
selecting at least one of the displayed letters;
selecting a position in the letter input window; and
moving and displaying the selected at least one letter to the selected position.

2. The method of claim 1, further comprising:
displaying a line-like cursor in the letter input window.

3. The method of claim 2, wherein selecting at least one of the displayed letters comprises:
receiving a first touch inputted at one of the displayed letters or inputted between the displayed letters;
displaying the cursor in an input position of the first touch;
receiving a second touch inputted at the displayed cursor more than a given time;
changing the line-like cursor into a block-like cursor;
receiving a drag inputted along at least one of the displayed letters; and
finding the at least one letter in an input path of the drag.

4. The method of claim 3, wherein selecting at least one of the displayed letters comprises:
changing a graphic representation of the at least one letter found in the drag path.

5. The method of claim 2, wherein selecting at least one of the displayed letters comprises:
receiving a touch inputted at one of the displayed letters;
determining whether the touch is inputted more than a given time;
if the touch is inputted more than the given time, changing the line-like cursor into a block-like cursor;
receiving a drag inputted along at least one of the displayed letters; and
finding the at least one letter in an input path of the drag.

6. The method of claim 5, wherein selecting at least one of the displayed letters comprises:
changing a graphic representation of the at least one letter found in the drag path.

7. The method of claim 1, further comprising:
displaying a line-like cursor at the selected position; and
receiving a touch inputted at the displayed cursor.

8. The method of claim 7, wherein moving and displaying the selected at least one letter comprises:
after receiving the touch inputted at the displayed cursor, moving and displaying the selected at least one letter to the selected position.

9. The method of claim 1, wherein selecting the position comprises:
receiving a touch inputted at the selected at least one letter;
receiving a drag inputted in the letter input window; and
finding an end position of the drag.

10. The method of claim 1, wherein selecting at least one of the displayed letters comprises:
receiving a touch inputted at one of the displayed letters or inputted between the displayed letters;
receiving a drag inputted along at least one of the displayed letters;
finding the at least one letter in an input path of the drag; and
determining whether a direction of the drag is a first direction or a second direction.

11. The method of claim 10, wherein moving and displaying the selected at least one letter comprises:
if the drag direction is the first direction, cutting the selected at least one letter found in the drag path and then pasting the selected at least one letter onto the selected position; and
if the drag direction is the second direction, copying the selected at least one letter found in the drag path and then pasting the selected at least one letter onto the selected position.

12. The method of claim 2, wherein selecting at least one of the displayed letters comprises:
moving the cursor in response to a first input of a navigation key;
changing the line-like cursor into a block-like cursor in response to an input of a first key;
changing a graphic representation of at least one letter selected by the passage of the block-like cursor in response to a second input of the navigation key; and
determining the selected at least one letter as a letter to be moved or copied in response to an input of a second key.

13. The method of claim 12, wherein moving and displaying the selected at least one letter comprises:
in response to a second input of the second key, cutting or copying the selected at least one letter and then pasting the selected at least one letter onto the selected position.

14. The method of claim 12, wherein selecting at least one of the displayed letters comprises:
after the changing of graphic representation, determining whether the navigation key in the second input is a rightward key or a leftward key, and
wherein the determining of the selected at least one letter includes:
if the navigation key in the second input is the rightward key, determining the selected at least one letter as the letter to be moved; and
if the navigation key in the second input is the leftward key, determining the selected at least one letter as the letter to be copied.

15. The method of claim 2, wherein selecting at least one of the displayed letters comprises:
moving the cursor in response to a first input of a navigation key less than a first given time;
changing the line-like cursor into a block-like cursor in response to a second input of the navigation key more than the first given time;
changing a graphic representation of at least one letter selected by the passage of the block-like cursor in response to a third input of the navigation key less than a second given time;
determining the selected at least one letter as a letter to be moved or copied in response to a fourth input of the navigation key more than the second given time; and
moving the cursor to the selected position in response to a fifth input of the navigation key more than a third given time.

16. The method of claim 15, wherein moving and displaying the selected at least one letter comprises:
in response to a sixth input of the navigation key more than a fourth given time, cutting or copying the selected at least one letter and then pasting the selected at least one letter onto the selected position.

17. The method of claim 15, wherein selecting at least one of the displayed letters comprises:
after the changing of graphic representation, determining whether the navigation key in the third input is a rightward key or a leftward key, and
wherein the determining of the selected at least one letter includes:
if the navigation key in the third input is the rightward key, determining the selected at least one letter as the letter to be moved; and
if the navigation key in the third input is the leftward key, determining the selected at least one letter as the letter to be copied.

18. A mobile device comprising:
a display unit configured to display a letter input window, at least one letter and a cursor;
an input unit comprising at least one key and configured to receive user's input instructions; and
a control unit configured to enable the display unit to display letters inputted by a user in the letter input window, to select at least one of the displayed letters through the input unit, to select a position in the letter input window through the input unit, and to enable the display unit to move and display the selected at least one letter to the selected position.

19. The mobile device of claim 18, wherein the input unit and the display unit comprise a touch screen.

20. The mobile device of claim 19, wherein the control unit is further configured to enable the touch screen to receive a first touch inputted at one of the displayed letters or inputted between the displayed letters, to display the cursor in an input position of the first touch, to receive a second touch inputted at the displayed cursor more than a given time, to change the cursor into a block-like cursor, to receive a drag inputted along at least one of the displayed letters, and to find the at least one letter in an input path of the drag.
